(19) United States
(12) Patent Application Publication
(10) Pub. No.: US 2007/0112554 A1
(43) Pub. Date: May 17, 2007

(54) System of interactive dictionary

(76) Inventor: Gautam Dharamdas Goradia, MAHARASHIRA (IN)

Correspondence Address: INTELLECTUAL PROPERTY LAW GROUP LLP, 12 SOUTH FIRST STREET, SUITE 1205, SAN JOSE, CA, 95113, US

(21) Appl. No.: 10/556,564

(22) PCT Filed: Oct. 1, 2003
(86) PCT No.: PCT/IN03/00327

§ 371 Date: Nov. 8, 2005

(30) Foreign Application Priority Data
May 14, 2003 (IN) 487/MUM/2003

(51) Int. Cl. G06F 17/28

(52) U.S. Cl. 704/4

(57) ABSTRACT

System for building one's own interactive dictionary and/or thesaurus of words, terms, phrases, etc. in one or more languages. It being accepted that one may want to build such data based on one's personal interest of vocabulary in one or more languages by well-defined classifications that uses a computer.

### FIELD OF INVENTION

The present invention relates to a System for building (including saving, appending, retrieving, modifying) and sharing one's own interactive dictionary and/or thesaurus of words, terms, phrases, etc. (Vocabulary) for increasing, improving, evaluating one's own and others' knowledge of words, terms, phrases, etc. (Vocabulary) in one or more languages, it being accepted that one may want to build (including saving, appending, retrieving, modifying) such data based on one's personal interest of Vocabulary in one or more languages by well-defined classifications like the Source of Information, Type of Vocabulary, Dialect, Age Group, Difficulty Level, general or specific Subjects, Sub subjects, Part of Speech; add Personalized Pronunciations to the same (in the form of text as well as sound files), add Short and Long meanings (brief and detailed meanings) to the same, add details of the Origin to the same, add Multiple Usage Examples to the same; add Quiz Options to the same, to be used as part of an evaluation process; add Attributes like synonyms, antonyms, homonyms, homophones, homographs, Related Vocabulary, Glossary etc. to the same; add Image, Animation and/or Sound files to the same, Associate more information in the form of Files, URLs, Remarks to the same, translate the same into one or more languages of the user's choice; Delete unwanted Vocabulary by none or one or more of the above classifications; Print Vocabulary by none or one or more of the above classifications, as well as obtain a plurality of Reports by none or one or more of the above classifications.

### BACKGROUND OF THE INVENTION

It is accepted that traditionally, it has always been dictionary/thesaurus makers—and publishers who have been the ones to have -published dictionaries/thesauruses, and that, as individuals, one needs to refer to such dictionaries/thesauruses that are published by such makers and publishers from time to time, to learn about, or obtain more information about, a word, term, phrase, etc. (Vocabulary).

It is also accepted that dictionaries generally contain the entire Vocabulary for a given language thereby making dictionaries bulky, generic and general in nature, and dictionaries are used, as such, more as reference materials to learn about, or obtain more information about, words, terms, phrases, etc. (Vocabulary), rather than as tools, which would help people to increase and improve their Vocabulary, in that, there are no dictionaries/thesauruses that allow a user to evaluate oneself or others. Similarly, thesauruses generally contain only the synonyms and/or antonyms of a Vocabulary, and more often than not, they do not provide the meanings of the parent Vocabulary.

It is also accepted that generally Dictionaries and Thesauruses are produced separately, and as such, one therefore needs to refer to two reference materials for the same Vocabulary, instead of one common reference source. However, in cases where Dictionaries and Thesauruses are produced as a single reference source, they are generally produced as a single source, more as a matter of convenience in terms of one reference source, and generally would have one section as a Dictionary and the other section as a Thesaurus. This still means that a user would have to refer to two sections to look for related data for one Vocabulary item, if at all available.

It is also accepted that dictionaries/thesauruses do not generally classify the Vocabulary by Subjects, Age Groups, and Difficulty Levels, and further, dictionaries also generally do not provide additional information like Related Vocabulary, homographs, homonyms and homophones, thereby making it an incomplete reference material for users who may want to look for Vocabulary by such useful and important classifications.

Since people have no means to create their own dictionaries/thesauruses, as the creation of dictionaries/thesauruses is a complex and laborious process involving large amount of resources and infrastructure, people have no choice but to rely on traditional dictionaries/thesauruses (which contain a huge amount of Vocabulary) to learn about, or obtain more information about, words, terms, phrases, etc. (Vocabulary).

Consequently, people are unable to build (including saving, appending, retrieving, modifying) their own “personalized” dictionaries/thesauruses. Moreover, since dictionaries/thesauruses are not updated regularly, people have to wait for long periods of time for updated dictionaries/thesauruses to be published, to learn more about additions of new Vocabulary items to a language.

Also, traditionally, dictionaries/thesauruses contain static and moderate amount of information, and people may wish to add more information to their Vocabulary, for the purpose of better comprehension and recall, like the Source of Information, Type of Vocabulary, Dialect, Age Group, Difficulty Level, general or specific Subjects, Sub subjects, Part of Speech; add Personalized Pronunciations to the same (in the form of text as well as sound files), add Short and Long meanings (brief and detailed meanings) to the same, add details of the Origin to the same, add Multiple Usage Examples to the same; add Quiz Options to the same, to be used as part of an evaluation process; add Attributes like synonyms, antonyms, homonyms, homophones, homographs, Related Vocabulary, etc. to the same; add image, animation and/or sound files to the same, Associate more information in the form of files, URLs, remarks to the same; delete unwanted Vocabulary and print Vocabulary.

The Vocabulary of a language is always changing and growing. As life becomes more complex, people devise new words to describe the world around them irrespective of the language. To take a case in point, even though, the exact number of English words is not known, reliable estimates indicate that are about one million words in the English language and new words are being added continuously.

It is a well-accepted fact that Vocabulary is part of one's daily life, irrespective of the language,

and people like to increase their knowledge of Vocabulary from time to time, especially in their

respective fields and age groups. People are continually building their Vocabulary. Studies show that a child in school may know only about 3,000 to 4,000 words but by adulthood may know about 10,000 to 30,000 words.

It is a well-accepted fact that people generally tend to use Vocabulary that they are comfortable with, which is usually limited in nature, resulting in repetitive usage of the same. Using a wide variety of words makes for interesting listening and reading, resulting in better impact. A better Vocabulary also helps in a clearer perception of ideas, and can thus be seen as a measure of a person's intellect.

Because Vocabulary is a part of daily life, there is a lot of emphasis on building one's knowledge of the same and several higher educational courses require that those intending to pursue such courses are well versed in course-related and/or in general Vocabulary, including the knowledge of Vocabulary in several languages.

It is a well-accepted fact that there are several popular Word Games like Scrabble, Crossword, Anagrams, Word Puzzles, etc., Television Programs like Spelling Bee, etc. and people like to play such games/take part in such Television Programs, which require therm to be well-versed with a large amount of Vocabulary, and it would be of immense use for lovers of such games and Television Programs, if there were to exist a System, which would allow them to improve their Vocabulary by offering them the possibility of building their own interactive dictionary and/or thesaurus which would, inter alia, allow users to find Vocabulary for the purpose of Practice and Evaluations, by the classifications under which the Vocabulary was stored and/or modified, including the possibility of finding the Vocabulary by a Phonetic search condition, and/or by the length of the Vocabulary search condition, and/or by the Attributes added to the Vocabulary like synonyms, antonyms, homonyms, homophones, homographs, Related Vocabulary, Glossary etc. and/or by the remarks added to the same, and/or by wildcards, and/or by supplying to the System one or more Attributes and requesting for the Related Vocabulary and vice versa, and/or by one or more characters, with a further possibility of including or excluding one or more characters in the search condition, and/or by any attached media files and/or by bookmark remarks, and/or by classifications like “Public”, “Private”, “Favourite”.

It is a well-accepted fact that people generally cannot remember large amounts of data, whether

by classifications or not, without external help, and it would be very helpful if there were to exist

a System that would help people to add, append, retrieve, modify, delete, print, export, import,

schedule, practice, and evaluate oneself and others with such data.

It is a well-accepted fact that there are no such Systems currently available which would allow a user to build (including saving, appending, retrieving, modifying) and share one's own interactive dictionary and/or thesaurus of words, terms, phrases, etc. (Vocabulary) for increasing, improving, evaluating one's own and others' knowledge of words, terms, phrases, etc. (Vocabulary) in one or more languages, whether or not by well-defined classifications, which further allow the user to practice the same, schedule the same for display at preset time intervals on their computers, including hand held devices, and to evaluate the user's and others' knowledge gathered on Vocabulary, in interesting and stimulating formats.

U.S. Pat. No. 6,453,280 relates to an electronic dictionary having an idiom processing function which can automatically identify idioms included in a present sentence from text of a first language, and which can output corresponding translated expressions in a second language. The electronic dictionary is operative to perform a technique which comprises an idiom processing operation which makes automatic identification possible by text capturing, sentence segmenting, local parsing and transfer lexicon matching. The electronic dictionary provides intelligent translation at the idiom level.

U.S. Pat. No. 6,192,333 relates to a computer readable medium which has computer executable components that include a morphological analyzer capable of using a corpus of words to automatically form a dictionary containing words associated with respective lemmas and respective parts of speech. The computer executable components also include a dictionary analyzer capable of automatically improving such a dictionary.

U.S. Pat. No. 6,151,598 relates to a digital dictionary system comprising a means for constructing and maintaining a single or plurality of Vocabulary data structure which is represented as a selective single or plurality of alphabet, sign, symbol, number, character, or code with a means for communicating with a selective one or a plurality of user applications for receiving, prioritizing, maintaining, and updating a selective one or a plurality of lists of subjects of interest for each user application. The Vocabulary data structure has a means for associating a single or plurality of Vocabulary data structures with each of the subjects of interest as defined by a selective one or plurality of users or applications.

U.S. Pat. No. 5,007,019 relates to an electronic dictionary that has a keyboard for entering words, which words are displayed along with a set of synonyms divided into subsets, each subset having a displayed common core meaning. The original word entered by the user for which synonyms and related words are sought is put into a history list. The user can select any of the synonyms or any of the words from the core meaning presented, or can independently enter any desired word and add those entered words to the history list. In this fashion, the user can build up a history list that can be reviewed by the user and any word in the history list re-accessed, so that the user can track through the history list and explore any desired complex arrangement of concepts, ideas, and relationships. As the history list becomes full, the earliest additional entry words are deleted in sequence.

U.S. Pat. No. 4,991,135 relates to an electronic dictionary comprising an input device, a display, a dictionary memory, a searching device, and an indicator device. The memory consists of plural divisions of equal storage capacity and stores multiple sets of word data representative of different words in an alphabetical order. Each set of word data is stored in one of the plural divisions such that each of the divisions has at its end a waste portion storing no part of any of the multiple sets of word data, if the number of characters of the first set of word data stored in the following division is larger than the number of characters which may be stored in the waste portion. In response to input data entered through the input device, the display displays the input data, and the searching device finds, in a binary search process, one of the plural divisions of the memory which is assigned to store the set of word data representative of the input data, and scans the found division to search the set of word data representative of the input data. The indicator device indicates whether the set of word data representative of the input data has been found or not.

U.S. Pat. No. 4,912,671 relates to Data E of index words C and their description D are stored in a large capacity memory medium (ROM). The data E is read by means of a ROM player, an index word C once retrieved and all or a portion of its description are stored in a RAM memory in the form of a word lists characterized by an attribute note to define the nature of the list, such as memorized and unmemorized words. A learning assistant function is provided to recall selected words from the list, permitting a user to practice the user's memory etc. The dictionary may be in a single language in which the words indexed and their descriptions are indicated by the single language, e.g. the English-English dictionary etc., or the dictionary may be in multiple or plural languages in which the index word C and its description D are indicated by different languages, e.g., the English-Japanese dictionary etc.

U.S. Pat. No. 4,489,396 relates to a portable word information storage device that comprises an input device for entering a specific word or words in a first language, a translator for producing a translated word or words equivalent to the specific word or words, and a voice synthesizer for developing pronunciation of the specific word or words in the first language. The pronunciation of the specific word or words can be repeated in response to an actuation of a repeat key switch. The pronunciation is generated in the same form as one reads it and, otherwise, of spelling or alphabetizing it.

U.S. Pat. No. 6,554,617 B1 relates to a Vocabulary Teaching Aid System providing for selection of a desired Vocabulary word from the screen presentation and presenting a usage example of the selected Vocabulary word.

U.S. Pat. No. 6,604,947 relates to an education method for aiding to teach and learn proper English reading, sounding and spelling. The method is designed in being able to teach and to learn reading with the proper sounding of the English alphabet rapidly with minimal instruction and supervision. It employs colors and symbols to represent 18 vowel sounds, 30 consonant, phonogram sounds and silent sounds. Each colored alphabet letter with or without symbol maps a designated sound that helps to depict a correct sounding from various spelled combinations of the English language. This color and symbol mapping method facilitates teaching reading of the English words as well as to spell correctly. It reduces long intensive phonic drills as well as guessing mistakes from a various possible sounding.

The prior art Systems described in the foregoing descriptions have an inherent limitation, in that, they do not allow the user to build their own interactive Dictionary and/or Thesaurus, and further that none of the above prior art assist in the improvement of one's Vocabulary by allowing users to practice, share and/or take self evaluation tests and/or test others' knowledge of Vocabulary.

Therefore, by dint of determined research and intuitive knowledge, our inventor has developed a System that enables users to build (including saving, appending, retrieving, modifying) their own interactive dictionaries and/or thesauruses of words, terms, phrases etc. (Vocabulary) in one or more languages of their choice, by well-defined classifications, translate the same into one or more languages, and which further enables users to improve their and others' knowledge of words, terms, phrases etc. (Vocabulary) in one or more languages by means of Practice Sessions, scheduled displays and self evaluation Tests; and which further enables them to monitor their progress; and which further enables users to create Tests and Quizzes; and which further enables users to evaluate others on their knowledge of words, terms, phrases etc. (Vocabulary) and to monitor their progress, and which further enables users to improve their and others' knowledge of words, terms, phrases, etc. (Vocabulary) on different languages, by taking Inter-Language Tests, and which further enables users to export their words, terms, phrases etc. (Vocabulary) to other users of this System, and which further allows users to import words, terms, phrases etc. (Vocabulary) built by other users of this System.

### BRIEF SUMMARY OF THE INVENTION

An object of the present invention is to provide a System for building (including saving, appending, retrieving, modifying) and sharing one's own interactive dictionary and/or thesaurus of words, terms, phrases, etc. (Vocabulary) for increasing, improving, evaluating one's own and others' knowledge of words, terms, phrases, etc. (Vocabulary) in one or more languages, it being accepted that one may want to build (including saving, appending, retrieving, modifying) such data in one or more languages based on one's personal interest of Vocabulary, further stored by various classifications like Source of Information, Type of Vocabulary, Dialect, Age Groups, Difficulty Levels, general or specific Subjects and Sub subjects and Parts of Speech, such classification of data not being restricted to any already provided data.

Yet another object of the present invention is to allow the user to FIND such data rapidly and efficiently by none or one or more FIND conditions.

Yet another object of the present invention is to allow users to add Personalized Pronunciations (in the form of text as well as sound files), allowing the addition of Short and Long Meanings (brief and detailed meanings), allowing the addition of details of Origin, allowing the addition of Multiple Usage Examples, allowing the addition of Quiz Options to be used as part of an evaluation process, allowing the addition of Attributes to each Vocabulary like synonyms, antonyms, homographs, homonyms, homophones, Related Vocabulary etc., allowing the addition of Glossary, Bookmark Remarks, Associations, Attaching of Files, including Media files, URLs and more Remarks to the same.

Yet another object of the present invention is to allow users to Customize the data by allowing the Modification of the same.

Yet another object of the present invention is to allow users to mark selected Records as “Set for Practice” or “Mastered” and assign the same to specific users or user groups.

Yet another object of the present invention is to allow users to mark selected Records as “Private” or “Public” and assign the same to specific users or user groups.

Yet another object of the present invention is to allow users to mark selected Records as “Favourite” and assign the same to specific users or user groups.

Yet another object of the present invention is to allow users to Navigate efficiently between the Records.

Yet another object of the present invention is to allow users to Modify data individually and Globally, and further selectively.

Yet another object of the present invention is to allow users to Share data created by the users using the Export/Import/Print modules, such Exporting/Importing/Printing of data capable of being done selectively.

Yet another object of the present invention is to provide users with the utility of Deleting the data, the scope of deleting data being singular or Global, sending the deleted data to the Recycle Bin Module of the System, and further permanently deleting the same, singularly or Globally, and/or restoring the same, singularly or Globally.

Yet another object of the present invention is to allow users to invoke Practice Session(s) using the stored data and finding the same by none or one or more classifications that the user may have used to create and/or modify such data, and further to use the Records selected for the Practice Session(s) as screen savers.

Yet another object of the present invention is to allow the user to Schedule the Vocabulary using the stored data by finding the stored data to be used based on none or one or more FIND conditions, to be brought up on the user's computer, including hand held devices, at preset time intervals, with or without Voice.

Yet another object of the present invention is to allow users to take Self Evaluation Tests by finding the stored data to be used for such Tests based on none or one or more FIND conditions, in various interesting, interactive and stimulating Formats, and to present them with evaluation reports.

Yet another object of the present invention is to allow users to create Tests or Quizzes rapidly, for the purpose of written Tests or Quizzes, by finding the stored data to be used for such Tests or Quizzes based on none or one or more FIND conditions, in various interesting Formats.

Yet another object of the present invention is to allow users to create Tests and/or Quizzes by various classifications, by finding the stored data to be used for such Tests and/or Quizzes based on none or one or more FIND conditions, in various interesting Formats, and with the further utility of being able to create such Tests and/or Quizzes using a backtracking utility to ensure that the selected Vocabulary items are not being duplicated, and further providing the utility of exporting the Vocabulary items or of providing the utility of exporting the Test and/or Quiz itself.

Yet another object of the present invention is to provide various Reports selectively and having the further utility of customizing the same.

Yet another object of the present invention is to provide the necessary Tools to the user for better customization and maintenance of the System in various ways.

Yet another object of the present invention is to allow one or more module(s)/utility(s) to Operate within a browser and/or other viewing and/or processing programs, and which can operate on one or more computers, including hand held devices.

Yet another object of the present invention is to provide a utility for creating, editing, deleting, printing, navigating, finding Masters like User, Info Source, Type of Vocabulary, Age Group, Dialect, Difficulty Level, Subject and Sub subjects, Part of Speech, Language, Test/Quiz Name, Test/Quiz Venue, Category, Sub Category, etc. with sufficient security so as not to allow the deletion of any Master of a Record that may be in use.

Yet another object of the present invention is to provide users with a Translation utility, allowing the user to consider any Record as a parent language Record and translate the same into one or more languages of the user's choice, the translation activity happening from a Translation Module which is invoked in the Vocabulary Bank Module, and further that all of the features and/or utility(s)/functionality(s) of the System remaining common to the translated Record as would be applicable to the parent language Record.

Yet another object of the present invention is to allow the user to print any Vocabulary of the user's choice as well as to obtain a plurality of Reports.

Yet another object of the present invention is to allow the user to input and/or modify data in the Vocabulary Bank Database/Translation Database by Voice input, with or without a conjunction of input made by keyboard support, and/or to use any other utility(s)/functionality(s) of the System, as may be supported by the System for such use, by Voice Command, and further to allow the user to receive Voice Output of the data so entered/modified by the user in the above Vocabulary Bank Database/Translation Database.

### BRIEF DESCRIPTION OF THE DRAWINGS

To complement the description that is being given and in order to promote a better understanding of the characteristics of the invention in accordance with a practical embodiment of the same and as an integral part of the said description a set of drawings accompany it in which, in an illustrative and non-restrictive way, the following are represented:

FIG. 1 is the diagram of the System block of the present invention.

FIG. 2 is the diagram of the Multiple User System of the present invention

FIG. 3 is the diagram of the Outline of the System Process of the present invention

FIG. 4 is the diagram of the System Function of Vocabulary Bank Module of the present invention

FIG. 5 is the diagram of the System Operation of Vocabulary Bank Module of the present invention

FIG. 6 is the diagram of the System State Transition of Vocabulary Bank Module of the present invention

FIG. 7 is the diagram of the System Function of Global Association Module of the present invention

FIG. 8 is the diagram of the System Operation of Global Association Module of the present invention

FIG. 9 is the diagram of the System State Transition of Global Association module of the present invention

FIG. 10 is the diagram of the System Function of Global Attachment Module of the present invention

FIG. 11 is the diagram of the System Operation of Global Attachment Module of the present invention

FIG. 12 is the diagram of the System State Transition of Global Attachment Module of the present invention

FIG. 13 is the diagram of the System Function of Practice Session Module of the present invention

FIG. 14 is the diagram of the System Operation of Practice Session Module of the present invention

FIG. 15 is the diagram of the System State Transition of Practice Session Module of the present invention

FIG. 16 is the diagram of the System Function of Take a Test Module of the present invention

FIG. 17 is the diagram of the System Operation of Take a Test Module of the present invention

FIG. 18 is the diagram of the System State Transition of Take a Test Module of the present invention

FIG. 19 is the diagram of the System Function of Individual Test Report Module of the present invention

FIG. 20 is the diagram of the System Operation of Individual Test Report Module of the present invention

FIG. 21 is the diagram of the System State Transition of Individual Test Report Module of the present invention

FIG. 22 is the diagram of the System Function of Overall Evaluation Report Module of the present invention

FIG. 23 is the diagram of the System Operation of Overall Evaluation Report Module of the present invention

FIG. 24 is the diagram of the System State Transition of Overall Evaluation Report Module of the present invention

FIG. 25 is the diagram of the System Function of Reports Module of the present invention

FIG. 26 is the diagram of the System Operation of Reports Module of the present invention

FIG. 27 is the diagram of the System State Transition of Reports Module of the present invention

FIG. 28 is the diagram of the System Function of Insta Test/Quiz Module of the present invention

FIG. 29 is the diagram of the System Operation of Insta Test/Quiz Module of the present invention

FIG. 30 is the diagram of the System State Transition of Insta Test/Quiz Module of the present invention

FIG. 31 is the diagram of the System Function of Create a Test/Quiz Module of the present invention

FIG. 32 is the diagram of the System Operation of Create a Test/Quiz Module of the present invention

FIG. 33 is the diagram of the System State Transition of Create a Test/Quiz Module of the present invention

FIG. 34 is the diagram of the System Function of Set for Practice/Mastered Items Module of the present invention

FIG. 35 is the diagram of the System Operation of Set for Practice/Mastered Items Module of the present invention

FIG. 36 is the diagram of the System State Transition of Set for Practice/Mastered Items Module of the present invention

FIG. 37 is the diagram of the System Function of Global Modification Module of the present invention

FIG. 38 is the diagram of the System Operation of Global Modification Module of the present invention

FIG. 39 is the diagram of the System State Transition of Global Modification Module of the present invention

FIG. 40 is the diagram of the System Function of Global Delete Module of the present invention

FIG. 41 is the diagram of the System Operation of Global Delete Module of the present invention

FIG. 42 is the diagram of the System State Transition of Global Delete Module of the present invention

FIG. 43 is the diagram of the System Function of Global Bookmark/Unbookmark Module of the present invention

FIG. 44 is the diagram of the System Operation of Global Bookmark/Unbookmark Module of the present invention

FIG. 45 is the diagram of the System. State Transition of Global Bookmark/Unbookmark Module of the present invention

FIG. 46 is the diagram of the System Function of Export Module of the present invention

FIG. 47 is the diagram of the System Operation of Export Module of the present invention

FIG. 48 is the diagram of the System State Transition of Export Module of the present invention

FIG. 49 is the diagram of the System Function of Import Module of the present invention

FIG. 50 is the diagram of the System Operation of Import Module of the present invention

FIG. 51 is the diagram of the System State Transition of Import Module of the present invention

FIG. 52 is the diagram of the System Function of Vocabulary Scheduler Module of the present invention

FIG. 53 is the diagram of the System Operation of Vocabulary Scheduler Module of the present invention

FIG. 54 is the diagram of the System State Transition of Vocabulary Scheduler Module of the present invention

FIG. 55 is the diagram of the System Function of Recycle Bin Module of the present invention

FIG. 56 is the diagram of the System Operation of Recycle Bin Module of the present invention

FIG. 57 is the diagram of the System State Transition of Recycle Bin Module of the present invention

FIG. 58 is the diagram of the System Function of Tools/Help Menu Options Module of the present invention

FIG. 59 is the diagram of the System Operation of Tools/Help Menu Options Module of the present invention

FIG. 60 is the diagram of the System State Transition of Tools/Help Menu Options Module of the present invention

FIG. 61 is the diagram of the System Function of Translation Module of the present invention

FIG. 62 is the diagram of the System Operation of Translation Module of the present invention

FIG. 63 is the diagram of the System State Transition of Translation Module of the present invention

FIG. 64 is the diagram of the System Function of Global Translation Module of the present invention

FIG. 65 is the diagram of the System Operation of Global Translation Module of the present invention

FIG. 66 is the diagram of the System State Transition of Global Translation Module of the present invention

FIG. 67 is the diagram of the System Function of Master Module of the present invention

FIG. 68 is the diagram of the System Operation of Master Module of the present invention

FIG. 69 is the diagram of the System State Transition of Master Module of the present invention

### DETAILED DESCRIPTION OF THE PRESENT INVENTION

A detailed description of the preferred embodiments and best modes for practicing the present invention are described herein.

System for building (including saving, appending, retrieving, modifying) and sharing one's own interactive dictionary and/or thesaurus of words, terms, phrases, etc. (Vocabulary) for increasing, improving, evaluating one's own and others' knowledge of words, terms, phrases, etc. (Vocabulary) in one or more languages, wherein

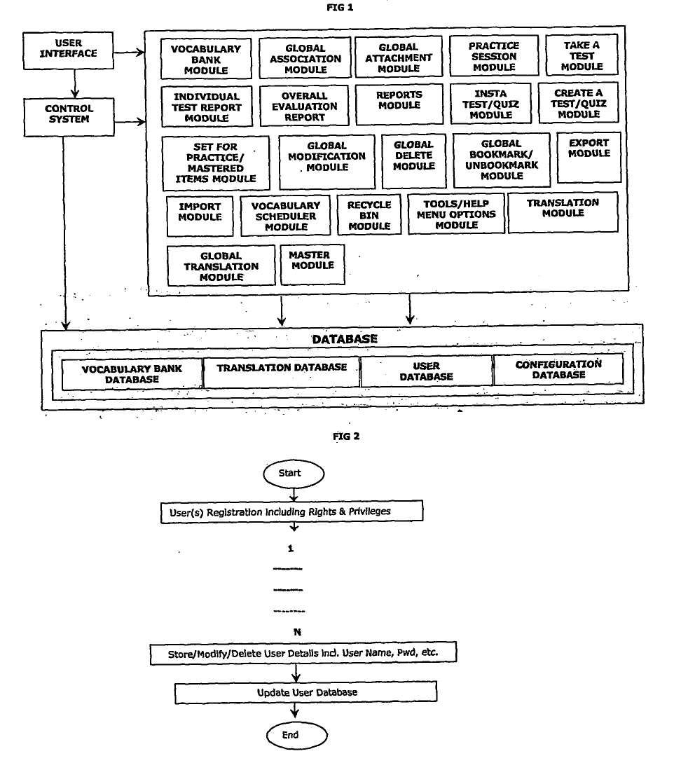

FIG. 1 is the diagram of the different functional blocks and their interaction, of the present invention. The User Interface renders the user's actions, and with the help of the Control System transmits the appropriate requests to the Database. The Control System acts as the bridge between the User Interface and the Database.

The Database consists of Vocabulary Bank Database, Translation Database, User Database and the Configuration Database. The Vocabulary Bank Database is the reservoir of an extensible collection of well-classified data. The Translation Database is the reservoir of the translated data. The User Database is the reservoir of the user information and also contains the history of past user interaction with the System. The Configuration Database is the reservoir of the options used for the Customization of the System.

If the user requests for the Vocabulary Bank Module through the User Interface then the Control System asks the Database Management System to find the corresponding data from the Vocabulary Bank Database/Translation Database, resulting in the display of the relevant data, if available. The user then interacts further with the Vocabulary Bank Module through the User Interface.

If the user requests for the Practice Session Module through the User Interface then the Control System asks the Database Management System to find the corresponding data from the Vocabulary Bank Database/Translation Database, resulting in the display of the relevant data, if available. The user then interacts further with the Practice Session Module through the User Interface.

If the user requests for the Take a Test Module through the User Interface then the Control System asks the Database Management System to find the corresponding data from the Vocabulary Bank Database/Translation Database, resulting in the display of the relevant data, if available. The user then interacts further with the Take a Test Module through the User Interface.

If the user requests for the Insta Test/Quiz Module through the User Interface, then the Control System asks the Database Management System to find the corresponding data from the Vocabulary Bank Database/Translation Database, resulting in the display of the relevant data, if available. The user then interacts further with the Insta Test/Quiz Module through the User Interface.

If the user requests for the Create a Test/Quiz Module through the User Interface, then the Control System asks the Database Management System to find the corresponding data from the Vocabulary Bank Database/Translation Database, resulting in the display of the relevant data, if available. The user then interacts further with the Create a Test/Quiz Module through the User Interface.

If the user requests for the Individual Test Report Module through the User Interface, then the Control System asks the Database Management System to find the corresponding data from the Vocabulary Bank Database/Translation Database, resulting in the display of the relevant data, if available. The user then interacts further with the Individual Test Report Module through the User Interface.

If the user requests for the Overall Evaluation Report Module through the User Interface, then the Control System asks the Database Management System to find the corresponding data from the Vocabulary Bank Database/Translation Database, resulting in the display of the relevant data, if available. The user then interacts further with the Overall Evaluation Report Module through the User Interface.

If the user requests for the Reports Module through the User Interface, then the Control System asks the Database Management System to find the corresponding data from the Vocabulary Bank Database/Translation Database, resulting in the display of the relevant data, if available. The user then interacts further with the Reports Module through the User Interface. Where any Report relates to user information, then the Control System asks the Database Management System to find the corresponding data from the User Database.

If the user requests for the Set for Practice/Mastered Items Module through the User Interface, then the Control System asks the Database Management System to find the corresponding data from the Vocabulary Bank Database/Translation Database, resulting in the display of the relevant data, if available. The user then interacts further with the Set for Practice/Mastered Items Module through the User Interface.

If the user requests for the Vocabulary Scheduler Module through the User Interface, then the Control System asks the Database Management System to find the corresponding data from the Vocabulary Bank Database/Translation Database, resulting in the display of the relevant data, if available. The user then interacts further with the Vocabulary Scheduler Module through the User Interface.

If the user requests for the Import Module through the User Interface, then the Control System retrieves the corresponding data from a valid Database file resulting in the display of the relevant data, if available. The user then interacts further with the Import Module through the User Interface.

If the user requests for the Export Module through the User Interface, then the Control System asks the Database Management System to find the corresponding data from the Vocabulary Bank Database/Translation Database, resulting in the display of the relevant data, if available. The user then interacts further with the Export Module through the User Interface.

If the user requests for the Translation Module through the User Interface, then the Control System asks the Database Management System to find the corresponding data from the Vocabulary Bank Database/Translation Database, resulting in the display of the relevant data, if available. The user then interacts further with the Translation Module through the User Interface.

If the user requests for the Tools/Help Menu Options Module through the User Interface, then the Control System retrieves the corresponding Options available from the Configuration Database. The user then interacts further with the Tools/Help Menu Options Module through the User Interface.

If the user requests for the Global Delete Module through the User Interface, then the Control System asks the Database Management System to find the corresponding data from the Vocabulary Bank Database/Translation Database, resulting in the display of the relevant data, if available. The user then interacts further with the Global Delete Module through the User Interface.

If the user requests for the Global Modification Module through the User Interface, then the Control System asks the Database Management System to find the corresponding data from the Vocabulary Bank Database/Translation Database, resulting in the display of the relevant data, if available. The user then interacts further with the Global Modification Module through the User Interface.

If the user requests for the Recycle Bin Module through the User Interface, then the Control System asks the Database Management System to find the corresponding data from the Vocabulary Bank Database/Translation Database and retrieves the corresponding data resulting in the display of the relevant data, if available. The user then interacts further with the Recycle Bin Module of the System through the User Interface.

If the user requests for the Global Bookmark/Unbookmark Module through the User Interface, then the Control System asks the Database Management System to find the corresponding data from the Vocabulary Bank Database/Translation Database, resulting in the display of the relevant data, if available. The user then interacts further with the Global Bookmark/Unbookmark Module through the User Interface.

If the user requests for the Global Translation Module through the User Interface, then the Control System asks the Database Management System to find the corresponding data from the Vocabulary Bank Database/Translation Database, resulting in the display of the relevant data, if available. The user then interacts further with the Global Translation Module through the User Interface.

If the user requests for the Global Association Module through the User Interface, then the Control System asks the Database Management System to find the corresponding data from the Vocabulary Bank Database/Translation Database, resulting in the display of the relevant data, if available. The user then interacts further with the Global Association Module through the User Interface.

If the user requests for the Global Attachment Module through the User Interface, then the Control System asks the Database Management System to find the corresponding data from the Vocabulary Bank Database/Translation Database, resulting in the display of the relevant data, if available. The user then interacts further with the Global Attachment Module through the User Interface.

If the user requests for the Master Module through the User Interface, then the Control System asks the Database Management System to find the corresponding data from the Vocabulary Bank Database/Translation Database, resulting in the display of the relevant data, if available. The user then interacts further with the Master Module through the User Interface. The relevant databases are updated on adding, modifying, and/or deleting.

FIG. 2 is the diagram of the Multiple User System of the present invention. It explains that multiple users can use the System at the same time, and also explains that the System can be controlled by rights and privileges. It further allows to Store/Modify/Delete the User Details including User Name, Password etc. in the User Database.

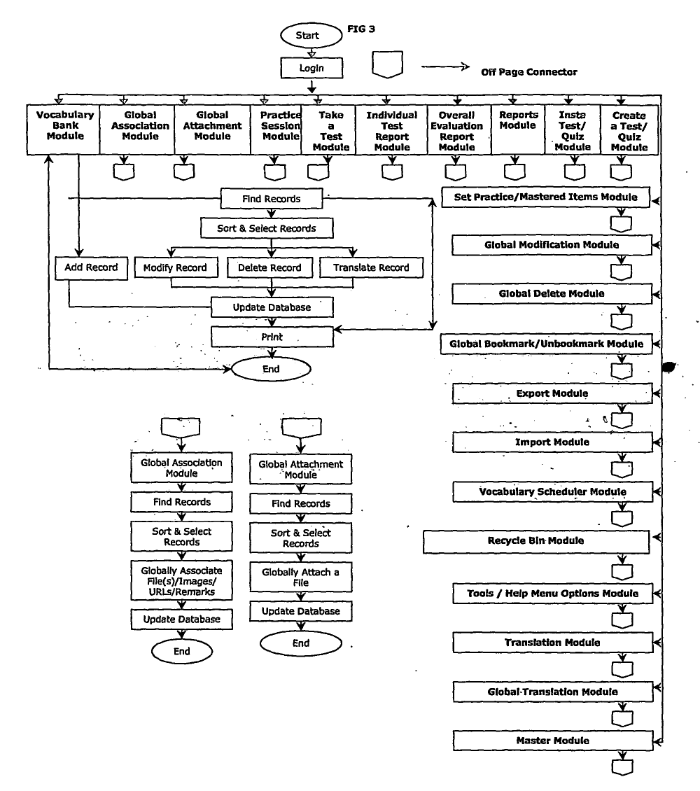

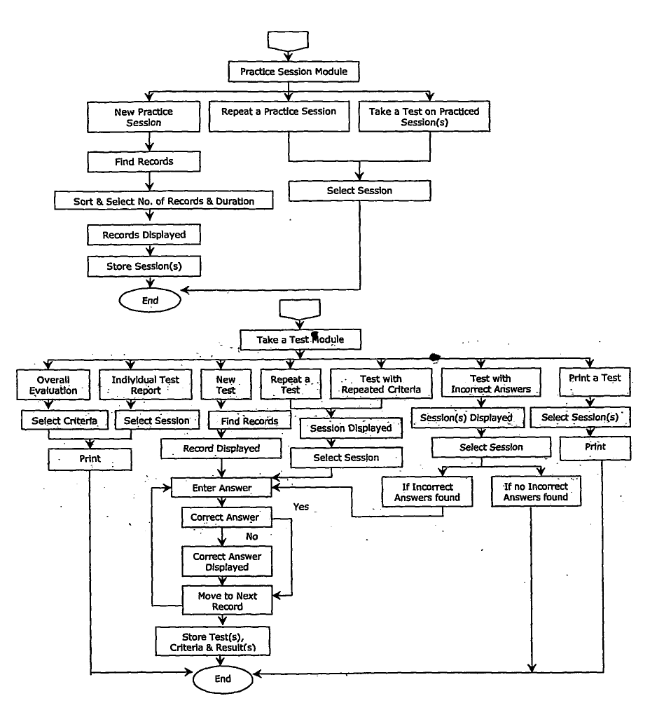

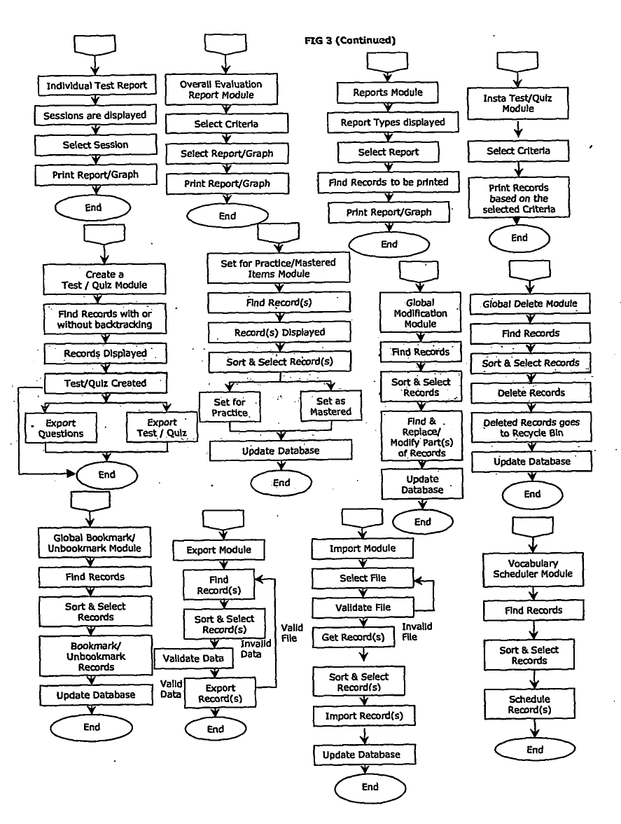

FIG. 3 is the diagram of the outline of the System process of the present invention. It exhibits the modules of the System and their main functions.

FIGS. 4 to 12 explain the System Function, System Operation, System State Transition of the Vocabulary Bank Module; System Function, System Operation, System State Transition of the Global Association Module; System Function, System Operation, System State Transition of the Global Attachment Module, respectively, of the present invention, The Vocabulary Bank Module accepts data in one or more languages (such data capable of being accepted from more than one user at the same time), with or without Voice, by well-defined classifications like (1) the Date (2) Source of Information (to record the Source from where the user obtained the details the user is entering—EXAMPLE—The user may have read a word, term, phrase, etc. in a particular book or magazine or dictionary—say “XYZ” and would like to store this Source of Information), (3) Type of Vocabulary (to record the Type of Vocabulary that the user is entering, e.g. word, term, phrase, etc.—EXAMPLE—“Elephant” may be classified as a Word, whereas “White Paper” may be classified as a Term, while “Odds and Ends” may be classified as a Phrase), (4) Dialect (to record the dialect that the Vocabulary item, that the user is entering, falls under—EXAMPLE—the word “VITAMIN” is pronounced as vit-ah-min in British English, but is pronounced as vye-tuh-min in American English), (5) This module further allows the user to add Personalized Pronunciations to the Vocabulary item, including the usage of special characters that help to explain the pronunciations (in the form of text and/or sound files), (6) Age Group (to record the relevant Age Group for which the Vocabulary item, that the user is entering, is meant for—EXAMPLE—the Vocabulary item may be meant for JUNIORS AGE GROUP or SENIORS AGE GROUP etc.), (7) Difficulty Level (to record the level of difficulty of the Vocabulary item that the user is entering for an age group), (8) Subject (to record the Subject under which the Vocabulary item, that the user is entering, is to be stored—EXAMPLE—The word “YAK” may be based on the subject, the ANIMAL WORLD and the user may want to store the same under the SUBJECT ANIMAL WORLD).(9) Sub Subject(s) (to record the Sub Subject (s) under which the details that the user is entering is to be stored—EXAMPLE—The word “YAK” may be based on the subject ANIMAL WORLD and the user may want to further classify the same up to 5 levels {Sub Subjects} e.g. SUBJECT>ANIMAL WORLD>SUB SUBJECT1>TERRESTRIAL ANIMAL>SUB SUBJECT2>MAMMAL >SUB SUBJECT3>QUADRUPED >SUB SUBJECT4>HERBIVORE>SUB SUBJECT5>WILD ANIMAL), (10) Part of Speech (to record the Part of Speech for the Vocabulary item that the user is entering—EXAMPLE—noun, verb, adverb etc.) The module further allows the user to search for existing Vocabulary by none or one or more of the above classifications, in order to avoid the duplication of entries.

This module further allows the user to add the meaning of the Vocabulary item in terms of a SHORT MEANING (brief meaning) and a LONG MEANING (detailed meaning). The module further allows the user to add the ORIGIN of the Vocabulary item and also allows the addition of MULTIPLE USAGE EXAMPLES of the Vocabulary item. This module further allows the user to add ATTRIBUTES to the Vocabulary item like synonyms, antonyms, homographs, homonyms, homophones, Related Vocabulary, etc, as well as to assign QUIZ OPTIONS which are used as part of an evaluation process.

The System also provides a utility to add a Glossary to the Vocabulary item.

The System also provides a utility to add specialized Remarks as “Bookmark Remarks”. The System also provides a utility to mark any selected Record(s) as “Set for Practice” or “Mastered”. The System also provides a utility to mark any selected Record(s) as “Private” or “Public”.

The System also provides a utility to mark any selected Record(s) as “Favourite” and further assign the same to specific users or user groups.

A Global utility allows the user to mark a set of Records as “Set for Practice” or “Mastered”, “Private” or “Public”, “Favourite”, globally, across multiple Records, by finding the same from the Vocabulary Bank Database/Translation Database by none or one of more FIND conditions, instead of marking the same one by one.

All of the above classifications and additional details and information are user defined, and can be modified to suit the user, thereby providing full flexibility to the user.

The System also comprises of the utility, while adding a new data Record, of copying an existing entry with respect to at least the above classifications under which the entry may have been stored, such “Copy Current Entry” utility being of immense use to the user to simplify the creation of Records having at least common classifications—EXAMPLE—If a user has an existing Record classified as:

TYPE: WORD

DIALECT: ENGLISH (U.K.)

AGE GROUP: GENERAL

DIFFICULTY LEVEL: HIGH

SUBJECT: ANIMAL WORLD

SUB SUBJECT1>TERRESTRIAL ANIMAL>SUB SUBJECT2>MAMMAL>SUB SUBJECT3>QUADRUPED>SUB SUBJECT4>HERBIVORE>SUB SUBJECT5>WILD ANIMAL

PART OF SPEECH: NOUN

And the new Record being added by the user also happens to be falling under the above classifications, the “Copy Current Entry” would make the new entry easier for the user, in that, the user would not have to reclassify the new entry.

The module further allows the user to Attach and/or Associate any kind of additional information like file(s), URLs and Remarks, file(s) and URLs being able to be opened by the System, the Remarks being simply displayed—EXAMPLE—The user may want to Attach an IMAGE and/or an ANIMATION and/or a SOUND file to the Record, or the user may also want to “Associate” more information to the Record by means of associating some information that may be on a file or a Web Site, and hence the user would Associate a file or URL to the Record. Such file(s) would be opened by the System. In case of a URL, the same would be opened by the System provided the user is connected to the Internet. The user may also simply wish to add a REMARK to the Record. Such REMARKS are displayed to the user on demand.

The System also comprises of the utility of Printing a Record stored in the Vocabulary Bank Database/Translation Database. The Records can be printed by finding the same from the Vocabulary Bank Database/Translation Database based on none or one or more FIND conditions, the Results being displayed to the user in a grid format with a further utility to Sort the Results, Ascending or Descending, by the relevant classifications, and further allowing the user to select the Records to be printed from the result grid. The Printing utility offers further selections to be made by the user with respect to various print conditions such as printing a single Record, or printing the results without further selections, or printing the results selectively, or printing the entire set of Records available in the database with further selections, if needed. The Printing utility further comprises of the Print reports to be Exported to various destinations in various file formats. The Printing utility provides the user with the ability to customize the Header and Footer details.

The System also comprises of the utility of Navigating between Records in the Vocabulary Bank Database/Translation Database.

The System comprises of the utility of Finding Records in the Vocabulary Bank Database/Translation Database, by none or one or more of the above classifications (and/or keywords including wildcards, length of Vocabulary, Plurality of Characters {with a choice to include or exclude such characters} used in a Vocabulary, by a Phonetic search, file attachments or bookmark remarks including, but not limited to, whether the Vocabulary item is marked as “Set for Practice” or “Mastered”, “Private” or “Public” as well as “Favourite” as well as by Attributes like synonyms, antonyms, homonyms, homophones, homographs, Related Vocabulary, etc.) that may have been used by the user to enter and/or modify the Records, the Find Results being displayed to the user in a grid format with a further utility to Sort the Find Results, Ascending or Descending, by the relevant classifications that may have been used by the user to enter and/or modify the Records in the data input module. Double clicking on any Record will take the user to the concerned Record.

A further utility allows the user to send the Record as SMS/MMS and/or via Email and/or Network Messaging.

The user is allowed to input and/or modify data in the Vocabulary Bank Module by Voice input, with or without a conjunction of input made by keyboard support, and/or use any other utility(s)/functionality(s) of the System, as may be supported by the System for such use, by Voice Command, and further that the text to speech technology used enables the System to speak out the data so entered/modified by the user in the above Vocabulary Bank Module.

The Vocabulary Bank Module also accepts data built by another user (Exporting user) of the System by the above classifications, and which data may be further manipulated by the Importing user to suit the Importing user's requirements (EXAMPLE—the Exporting user may have classified the subject of the word “YAK” as ANIMAL WORLD, but the Importing user may like to classify the subject of the same as WILD LIFE WORDS)

Any data from the Vocabulary Bank Database/Translation Database can be deleted by the user by finding the same based on none or one or more FIND conditions.

Any Record can be translated by the user into one or more languages by finding the same from the Vocabulary Bank Database/Translation Database based on none or one or more FIND conditions and translating the same into the selected language.

Any data entered or imported into the Vocabulary Bank Module is further used as part of the functions of the other modules of the System.

FIG. 4 is the diagram of the System Function of Vocabulary Bank Module of the present invention. The architecture of this module comprises the following functions, which allow a user to build, append, save, modify and delete Vocabulary by well-defined classifications, and add other details like the Pronunciations, Meanings, Origins, Usage Examples, Attach/Associate File(s)/Images/URLs/Remarks and Add Attributes/General Remarks, Glossary, Quiz Options, etc. to the Vocabulary item(s), with the help of the User Interface.

The Vocabulary Bank Module, through the User Interface, causes the Control System to find and retrieve the relevant data from the Vocabulary Bank Database/Translation Database. The module allows a user to:
Find existing Vocabulary by none or one or more FIND conditions
Sort & Select Vocabulary item(s)
Add, Modify, Delete & Save Vocabulary item(s) by classifications
Translate Vocabulary
Send Vocabulary item(s) as SMS/MMS and/or Network Messaging and/or Email
Copy Current Entry
Print Current Vocabulary item/Vocabulary item(s) by different classifications
Go To a Vocabulary item and Navigate between Vocabulary items
Bookmark/Unbookmark Vocabulary item(s) with various remarks, not limited to “Set for Practice” or “Mastered”, “Private” or “Public”, as well as “Favourite”
Attach/Associate File(s)/Images/URLs/Remarks and Add Attributes/General Remarks to a Vocabulary item
Assign Quiz Options

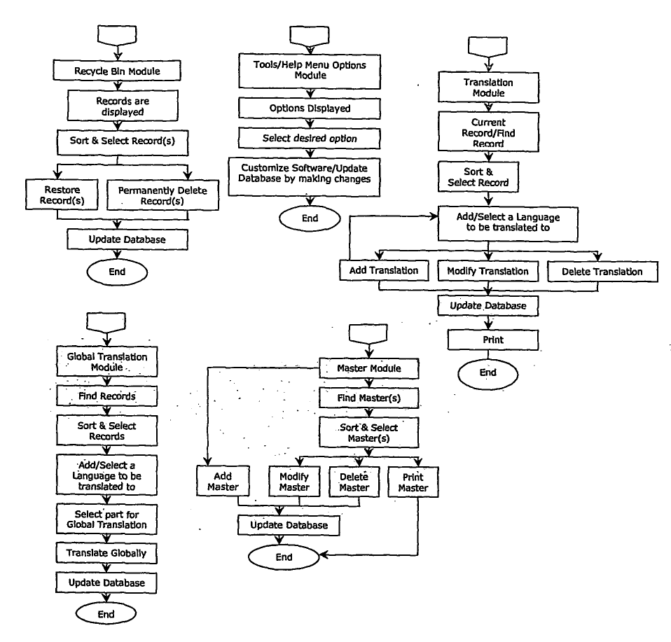

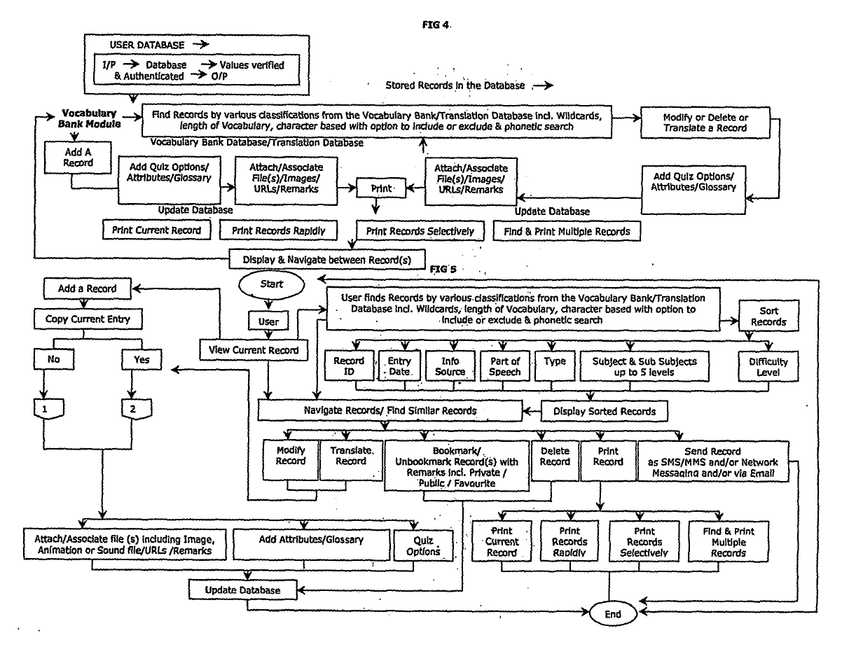

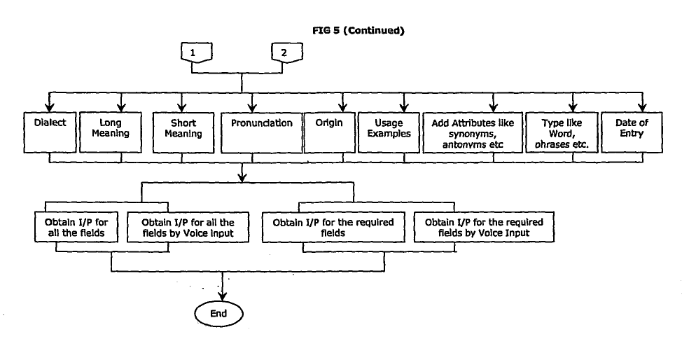

FIG. 5 describes the System Operation of the Vocabulary Bank Module explaining that the Module is based on user actions, which are performed by loops.

The Add functionality allows the user to Input data in the relevant fields. The functionality is controlled through a top-level loop. The Control System updates the Database and then the System waits for the next user action.

The FIND functionality is controlled through a top-level loop wherein the user is asked to enter/select a FIND criterion, to bring forth Vocabulary from the Vocabulary Bank Database/Translation Database based on the Find criteria. After finding the Vocabulary item(s), the user can Sort the Vocabulary item(s) by different classifications and then can modify, delete or print the Vocabulary item(s). After modification, if the user saves the Vocabulary item(s), the database gets updated and then the System waits for the next user action. Similarly, after deleting a Vocabulary item, the database gets updated and then the System waits for the next user action.

The Copy Current Entry functionality is controlled through a top-level loop. This functionality allows the user to copy the data existing in one or more of the fields of the current Vocabulary item and make the necessary additions/modifications in the other fields. The Control System updates the new Vocabulary item in the Database and then the System waits for the next user action.

The Printing functionality is controlled through a top-level loop. The user can print the Vocabulary facing the user, or can print Vocabulary that may have been found from the Vocabulary Bank Database/Translation Database, by a FIND criterion. The Control System retrieves the Vocabulary item(s) from the Database and then the System waits for the next user action.

The Bookmark/Unbookmark Vocabulary functionality is controlled through a top-level loop. The user can Bookmark/Unbookmark the Vocabulary facing the user, or can Bookmark/Unbookmark Vocabulary item(s) that may have been found from the Vocabulary Bank Database/Translation Database by a FIND criterion. Bookmarking requires that the user add some remarks to the Bookmark. The Control System updates the Database and then the System waits for the next user action. This functionality also allows the user to bookmark Vocabulary item(s) as “Private” or “Public”, “Set for Practice” or “Mastered” as well as “Favourite”.

The Quiz Options functionality is controlled through a top-level loop. If there exists some Vocabulary item(s) in the Vocabulary Bank Module, the System randomly brings forth 3 options based on the Subject under which the current Vocabulary item is being stored. The user is at liberty to accept or reject any of these 3 options. The user can also add new options by replacing one or more of the 3 options, but cannot modify the correct option. The correct option, which is the Short Meaning (brief meaning) of the Vocabulary item, is randomly posted by the System in any of the 4 fields. The System ensures that duplicate options are not accepted. The Control System updates the Database and then the System waits for the next user action.

The Translation functionality is controlled through a top-level loop. The user can Translate the Vocabulary item facing the user, or can Translate Vocabulary items that may have been found from the Vocabulary Bank Database/Translation Database by a FIND criterion. The Translation functionality allows the user to consider any Vocabulary item as a parent language Vocabulary item and translate the same into one or more languages of the user's choice. The Control System updates the Database and then the System waits for the next user action.

The user can send as SMS/MMS and/or via Email and/or Network Messaging the Vocabulary item facing the user, or can send Vocabulary item(s) that may have been found from the Vocabulary Bank Database/Translation Database, by a FIND criterion.

The user can Attach/Associate file(s) including Image, Animation and/or Sound Files, URLs/Remarks to the Vocabulary item facing the user, or can Attach/Associate file(s) including Image, Animation and/or Sound Files, URLs/Remarks to the Vocabulary item(s) that may have been found from the Vocabulary Bank Database/Translation Database, by a FIND criterion. The Attach/Associate file(s) including Image, Animation and/or Sound Files, URLs/Remarks functionality to a desired Vocabulary item is controlled through a top-level loop. The Control System updates the Database and then the System waits for the next user action.

The Navigation functionality allows the user to navigate between Vocabulary item(s).

On giving the Close command the System gets notified and the user comes out from the module.

FIG. 6 describes the State Transition Diagram of the Vocabulary Bank Module explaining that the Module is based on different States. The System receives events from the user(s), and each event causes the transition from one state to another within the module.

Each State contains its own separate Terminal State. A double lined transition arrow from State 4 indicates that multiple instances of the state are possible. So it is possible for multiple instances of State 4 to occur, each of which has its own Terminal State: A transition shown with a dotted line indicates that it is leaving from one State and entering another State.

FIG. 7 is the diagram of the System Function of Global Association Module of the present invention. The architecture of this module comprises the following functions, which allow a user to Associate File(s)/URLs/Remarks to Vocabulary item(s) globally by finding the Vocabulary item(s) from the Vocabulary Bank Database/Translation Database, by none or one or more FIND conditions with the help of the User Interface. The Global Association Module, through the User Interface, causes the Control System to find and retrieve the relevant data from the Vocabulary Bank Database/Translation Database and to Associate File(s)/URLs/Remarks to Vocabulary item(s) globally across several selected Vocabulary item(s) at a time.

FIG. 8 describes the System Operation of Global Association Module explaining that the Module is based on user actions, which are performed by loops. Through this Global Association Module, the user can Associate File(s)/URLs/Remarks to Vocabulary item(s) globally by finding the Vocabulary item(s) from the Vocabulary Bank Database/Translation Database, by various classifications with the help of the User Interface.

Once the user finds the Vocabulary item(s) from the Vocabulary Bank Database/Translation Database, by various classifications the user can Sort & Select the Vocabulary item(s) and then the System waits for the next user action. Then the user can Associate File(s)/URLs/Remarks to Vocabulary item(s) globally through the User Interface. The System then waits for the next user action.

On giving the Close command the System gets notified and the user comes out from the module.

FIG. 9 describes the State Transition Diagram of the Global Association Module explaining that the Module is based on different States. The System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIG. 10 is the diagram of the System Function of Global Attachment Module of the present invention. The architecture of this module comprises the following functions, which allow a user to Attach a File to Vocabulary item(s) globally by finding the Vocabulary item(s) from the Vocabulary Bank Database/Translation Database, by none or one or more FIND conditions with the help of the User Interface. The Global Attachment Module, through the User Interface, causes the Control System to find and retrieve the relevant data from the Vocabulary Bank Database/Translation Database and to Attach File(s) to the Vocabulary item(s) globally across several selected Vocabulary item(s) at a time.

FIG. 11 describes the System Operation of Global Attachment Module explaining that the Module is based on user actions, which are performed by loops. Through this Global Attachment Module, the user can Attach File(s) to Vocabulary item(s) globally by finding the Vocabulary item(s) from the Vocabulary Bank Database/Translation Database, by none or one or more FIND conditions with the help of the User Interface.

Once the user finds the Vocabulary item(s) by various classifications the user can Sort & Select the Vocabulary item(s) and then the System waits for the next user action. Then the user can Attach File(s) to Vocabulary item(s) globally through the User Interface. The System then waits for the next user action.

On giving the Close command the System gets notified and the user comes out from the module.

FIG. 12 describes the System State Transition Diagram of the Global Attachment Module explaining that the Module is based on different States. The System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

The System generates a new Record ID each time a new entry is made by a user or when a Record is imported by the user.

FIGS. 13 to 15 explain the System Function, System Operation and System State Transition respectively of the Practice Session Module, comprising of a utility of allowing the user to invoke and store a Practice Session, (such Practice Sessions being capable of being taken by more than one user at the same time), using the data stored in the Vocabulary Bank Database/Translation Database, and by finding the same based on none or one or more FIND conditions, the find results being displayed to the user with the time of display as may be selected by the user, for displaying each of the Records, and the Records being displayed one by one, until the number of Records found by the above FIND conditions are exhausted, or until the user exits the module, as well as further allowing the user to manually navigate between the Records being used in the Practice Session, as well as further allowing the user to make a selection as to whether the user wishes to listen to a Background Music Sound File during the Practice Session, as well as further allowing the user to make a selection as to whether the user wishes to listen to the text of the Vocabulary item(s), which is simultaneously displayed and spoken by a character through an embedded text to speech engine. The module further comprises of the utility of allowing the user to select the number of Records and the time of display per Record, the Records being randomly selected from the Database, but based on the FIND conditions, and displayed to the user on the user's computer, including handheld devices. The module further comprises of the utility of allowing the user to repeat the Practice Session and to take a Test on practiced session(s) from the previously stored Practice Session(s). The module further comprises of the utility of allowing the user to assign any previous Practice Session for the purpose of showing the data on the user's screen as a screen saver. A further utility allows the user to send any Record as SMS/MMS and/or via Email and/or Network Messaging during the Practice Session.

FIG. 13 is the diagram of the System Function of Practice Session Module of the present invention. The architecture of this module comprises the following functions, which allow a user to invoke a New Practice Session using the data stored in the Vocabulary Bank Database/Translation Database, and by finding the same based on none or one or more FIND conditions, to Repeat a Practice Session and to Take a Test on Practiced Session(s) from the previously stored Practice Session(s), with the help of the User Interface.

The Practice Session through the User Interface causes the Control System to find and retrieve the relevant data from the Vocabulary Bank Database/Translation Database. The module allows a user to:
Select a language in case of a single language Practice Session or select 2 languages in case of an Inter-Language Practice Session
Take a New Practice Session by finding the Vocabulary item(s) from the Vocabulary Bank Database/Translation Database, by none or one or more FIND conditions
Repeat a Practice Session
Take a Test on Practiced Session(s)
Navigate between Vocabulary item(s) during the Practice Session
Activate Background Music Sound File during the Practice Session
Activate Voice Assistant during the Practice Session
Send Vocabulary item(s) as SMS/MMS and/or via Email and/or Network Messaging during the Practice Session

FIG. 14 describes the System Operation of the Practice Session Module explaining that the Module is based on user actions, which are performed by loops.

To invoke a New Practice Session the user selects the language (1 language in case of single language Practice Session or 2 languages in case of Inter-Language Practice Session), User Name, Practice Session Title, No. of Vocabulary item(s) and Time per Record and then finds the Vocabulary item(s) from the Vocabulary Bank Database/Translation Database, by none or one or more FIND conditions. The System then waits for the next user action. The user can also select to listen to a Background Music Sound File or can activate the Voice Assistant during the Practice Session. The System then waits for the next user action. The user can also assign any previous Practice Session for the purpose of showing the data on the user's screen as a screen saver. The System then waits for the next user action. The user can also navigate between the Vocabulary item(s) and can also jump to any Vocabulary item at any point of time during the Session, and after this the user can notify the System that the Session is finished. The user can also send any Vocabulary item as SMS/MMS and/or via Email and/or Network Messaging. The System then waits for the next user action.

To Repeat a Practice Session the user selects the desired Practice Session from the previously stored Practice Session(s) containing User Name, and the Practice Session Title from all the Practice Session(s) taken earlier. The System then waits for the next user action.

To Take a Test on the Practiced Session(s) the user selects the desired Practice Session from the previously stored Practice Session(s) containing User Name, and the Practice Session Title from all the Practice Session(s) taken earlier. The System then waits for the next user action. The user then enters or selects the Practice Session Title, and also selects the Test Format and Time per Record to begin a Test on the Practiced Session(s). The System then waits for the next user action.

On giving the Close command the System gets notified and the user comes out from the module.

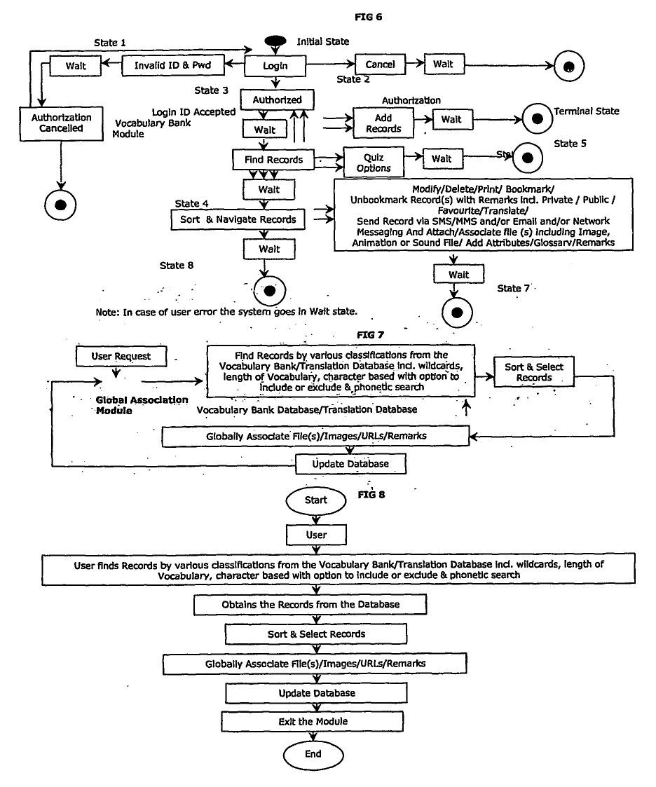

FIG. 15 describes the System State Transition Diagram of the Practice Session Module explaining that the Module is based on different States. The System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 16 to 24 explain the System Function, System Operation and System State Transition respectively of Take a Test Module, the System Function, System Operation and System State Transition of the Individual Test Report Module, the System Function, System Operation and System State Transition of the Overall Evaluation Report Module, respectively of the present invention, allowing the user to take a new Test, in one or more Test Formats (such Tests being capable of being taken by more than one user at the same time), using the data stored in the Vocabulary Bank Database/Translation Database, and by finding the same based on none or one or more FIND conditions, the FIND results being displayed to the user, based on the number of Records selected by the user to be used in the Test, along with the time per Record for the purpose of being displayed on the user's screen, and the Records being displayed one by one, until the number of Records found by the above FIND conditions are exhausted, or until the user exits the module, as well as further allowing the user to use the Hint Option while taking a Test, and displaying to the user the Record number and the time of display (being decreased per second) per Vocabulary item as may be selected by the user. The module further comprises of the utility of allowing the user to repeat a Test from the previously taken Test(s), to take a Test with Incorrect Answers, to take a Test with the Repeated Criteria (same criteria as the immediately preceding Test) or to select New Criteria from the previously stored Criteria. The System allows the user to select any one of the following Test formats:
Word Options—This format displays the Vocabulary item as the question and provides 4 options (that were assigned in the Vocabulary Bank), as the possible answers. The user must select one of the 4 options as the correct option. This format further comprises of the utility of a Hint Option, wherein a Hint is shown to the User. Using the Hint Option reduces the score of the user by a percentage as defined by the user for the current Vocabulary item.
Match Maker—This format comprises of left (Question) and right (Answer) columns, which allow the user to match the appropriate Vocabulary item in the columns, by clicking on any Vocabulary item in the left column & looking for the corresponding Answer in the right column or vice versa. Additional matches are provided in the right (Answer) column, to further challenge the user. This format further comprises of the utility of a Hint Option, wherein a Hint is shown to the User. Using the Hint Option reduces the score of the user by a percentage as defined by the user for the current Vocabulary item.
Hang-Over—This format comprises of a character grid and a clue, which allows the user to guess the Vocabulary item, either by clicking on the characters provided in the grid or by keyboard support, providing a limit of only 5 mistakes to the user for guessing the correct answer. If the user commits more than 5 mistakes then the user loses. This format visually displays a character with a human figure that is “hanged” on the 6^{th} error. This format further comprises of the utility of a Hint Option, wherein a Hint is shown to the User. Using the Hint Option reduces the score of the user by a percentage as defined by the user for the current Vocabulary item.
AcrossWord—This format comprises of a grid of a maximum of 10 rows, each row containing blanked boxes, which the user is supposed to fill with the Vocabulary item, which the user must guess, based on the clues that are provided corresponding to each row. This format further comprises of the utility of a Hint Option, wherein a Hint is shown to the User. Using the Hint Option reduces the score of the user by a percentage as defined by the user for the current Vocabulary item.
Word Juggler—This format comprises of scrambled Vocabulary item and a sentence, which contains the missing Vocabulary item, which is the scrambled Vocabulary item. The user unscrambles the scrambled Vocabulary item in the correct sequence to get the Answer.
Fill in the Blanks—This format comprises of blank characters, corresponding to the number of characters that are blanked in a statement. The user reads the statement with blanked Vocabulary item, and guesses the Vocabulary item by entering the blanked characters in the correct sequence using a keyboard. This format further comprises of the utility of a Hint Option, wherein the blanked Vocabulary item is scrambled, making it more meaningful for the user to understand the relevance of the blanked Vocabulary item. Using the Hint Option does not reduce the score of the user, since some kind of a hint is required for this format to explain the relevance of the blanked Vocabulary item.
Memory Challenge—This format comprises of Vocabulary items displayed to the user in a maximum of 10 rows. The user must read and memorize the Vocabulary items & after time out, must enter the Vocabulary items in the same or reverse order as seen in the earlier screen. At the end of the Test, the System provides the meanings of the Vocabulary items. In order to introduce an element of surprise, the System defines the order of entry randomly.
a Spelling Challenge—This format comprises of a blank field. The System speaks out the Vocabulary item to the user, who, after listening to the same must type the correct spelling of the same, before time out. It also comprises of the utility of ‘Say Again’ in case the user wishes to listen to the Vocabulary item once again. Using the ‘Say Again’ utility does not reduce the score, in order to allow the user to comprehend the pronunciation clearly.
Word Cousins—This format displays a Vocabulary item as a question and four options, one of which is either the Meaning or a Synonym or an Antonym or a Related Vocabulary item. Randomly, the System asks the user to provide either the Meaning or a Synonym or an Antonym or a Related Vocabulary item for the displayed Vocabulary item. This format further comprises of the utility of a Hint Option, wherein a Hint is shown to the User. Using the Hint Option reduces the score of the user by a percentage as defined by the user for the current Vocabulary item.
Figure Out—This format displays an image or animation as the question and 4 options, one of them being the Answer. This format further comprises of the utility of a Hint Option, wherein a Hint is shown to the User. Using the Hint Option reduces the score of the user by a percentage as defined by the user for the current Vocabulary item.

Upon completion of Test(s), this module also allows the user to Print a Test, to obtain an

Individual Test Report, and an Overall Evaluation Report by various classifications from the previously stored Result(s).

FIG. 16 is the diagram of the System Function of Take a Test Module of the present invention. The architecture of this module comprises the following functions, which allows a user to take a New Test by finding the Records from the Vocabulary Bank Database/Translation Database, by none or one or more FIND conditions including Test Formats with the help of the User Interface, to Repeat an immediately preceding Test, to repeat a Test taken earlier, to take a Test with Incorrect Answers from the previously stored Test(s), to take a Test with the Repeated Criteria (same criteria as the immediately preceding Test) from the previously stored Criteria.

Upon completion of Test(s), this module also allows the user to Print a Test, to obtain an Individual Test Report for a Test, and to obtain an Overall Evaluation Report by various classifications from the previously stored Result(s) with the help of the User Interface.

The Take a Test Module, through the User Interface, causes the Control System to find and retrieve the relevant data from the Vocabulary Bank Database/Translation Database. The module allows a user to:
Select a language
Take a new Test using data selected from the Vocabulary Bank Database/Translation Database, by none or one or more FIND conditions and Test Formats
Repeat a Test
Take a Test with Incorrect Answers
Take a Test with the Repeated Criteria (same criteria as the immediately preceding Test)
Obtain an Individual Test Report
Obtain an Overall Evaluation Report
Activate Background Music Sound File during the Test
Activate Voice Assistant during the Test
Print a Test

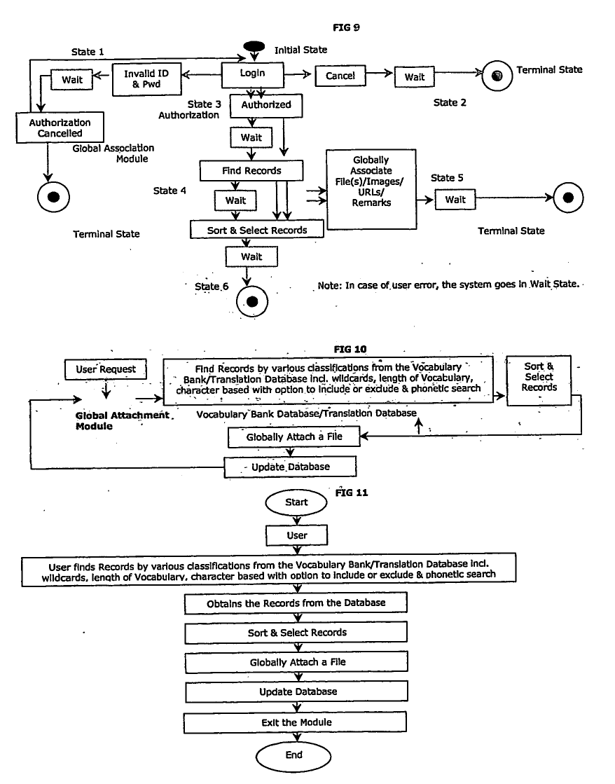

FIG. 17 describes the System Operation of the Take a Test Module explaining that the Module is based on user actions, which are performed by loops.

To take a New Test the user selects the Language, User Name, Test Title, No. of Records, Time per Vocabulary item, Test Format and then finds the Records from the Vocabulary Bank Database/Translation Database, by none or one or more FIND conditions from the Database. The System then waits for the next user action. The user can choose any one Test Format as explained earlier.

The user can also listen to a Background Music Sound File or can activate the Voice Assistant during the Test. The System then waits for the next user action. After this the user can notify the System that the session is finished. The System then waits for the next user action.

To Repeat an immediately preceding Test, the user sets the Test Repeat Options to Repeat Test. The System then repeats the Test, upon the same being completed without further user intervention. To Repeat a particular Test, the user selects the desired Test Session containing the User Name & Test Title from all the Test(s) taken earlier. The System then waits for the next user action. To take a Test with Incorrect Answer(s) the user selects the desired Test Session containing the User Name & Test Title from all the Test(s) taken earlier. Tests with such conditions will be repeated only when the selected Test contains Incorrect Answer(s). The System then waits for the next user action. To take a Test with the Repeated Criteria the user selects the desired Test Session containing the User Name & Test Title from all the Test(s) taken earlier. The System brings forth the Records of the same criteria as the selected Test from the previously stored Criteria. The System then waits for the next user action.

To Print a Test the user selects the desired Test Session from all the Test(s) taken earlier. The System then waits for the next user action. The user can print the selected Test. The System then waits for the next user action. The user can also print the answers for the selected Test, if needed.

To print an Individual Test Report the user selects the desired Test Session from all the Test(s) taken earlier. The System then waits for the next user action. The user can also print a Graph based on the selected Test Session. The System then waits for the next user action.

To obtain an Overall Evaluation Report, the user selects the criteria and the User Name. The System then waits for the next user action. The user can either print a Report or a Graph based on the selected criteria. The System then waits for the next user action.

On giving the Close command the System gets notified and the user comes out from the module.

FIG. 18 describes the System State Transition Diagram of the Take a Test Module explaining that the Module is based on the different States. The System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

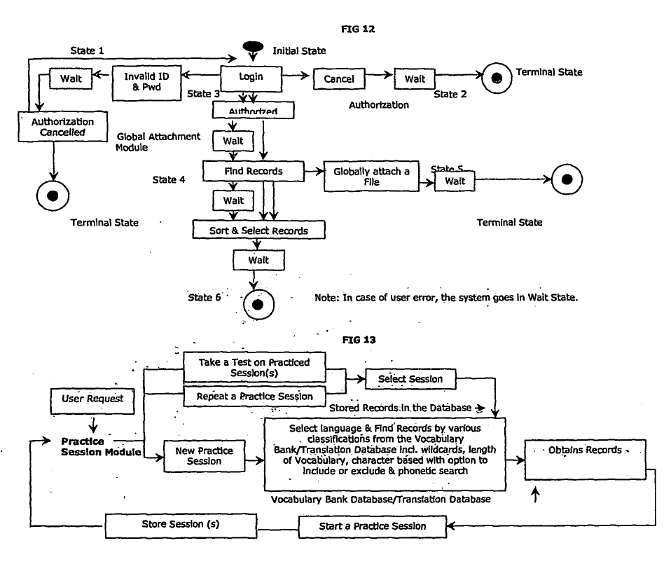

FIG. 19 is the diagram of the System Function of Individual Test Report Module of the present invention. The architecture of this module comprises the following functions, which allow a user to print an Individual Test Report by selecting the Test Session with the help of the User Interface.

The Individual Test Report Module, through the User Interface, causes the Control System to find and retrieve the selected Test Session from the Vocabulary Bank Database/Translation Database. The module allows a user to:
Select a Test Session
Print either the Report and/or Graph based on the selected Test Session

FIG. 20 describes the System Operation of the Individual Test Report Module explaining that the Module is based on user actions.

The user selects the Test Session. The System then waits for the next user action. The user can Print the Report and/or Graph for the Selected Test Session. The System then waits for the next user action.

On giving the Close command the System gets notified and the user comes out from the module.

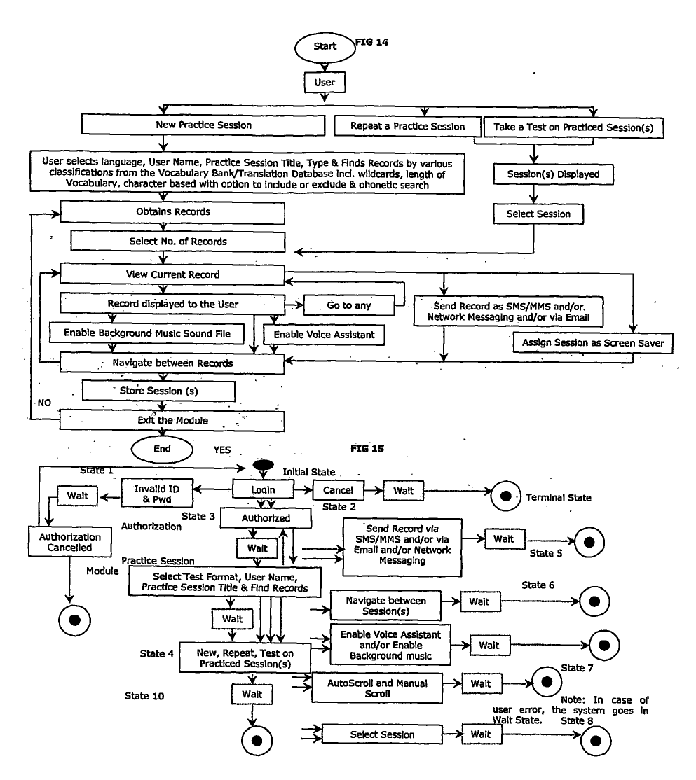

FIG. 21 describes the System State Transition Diagram of the Individual Test Report Module explaining that the Module is based on the different States. The System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIG. 22 is the diagram of the System Function of Overall Evaluation Report Module of the present invention. The architecture of this module comprises the following functions, which allow a user to obtain Overall Evaluation Reports by various classifications with the help of the User Interface. Overall Evaluation Reports are generated by the System based on Users, Age Groups, Subjects, Difficulty Levels and Type of Vocabulary.

The Overall Evaluation Report Module, through the User Interface, causes the Control System to find and retrieve the relevant data from Vocabulary Bank Database/Translation Database. The module allows a user to:
Select Criteria
Select Report/Graph
Print Report/Graph

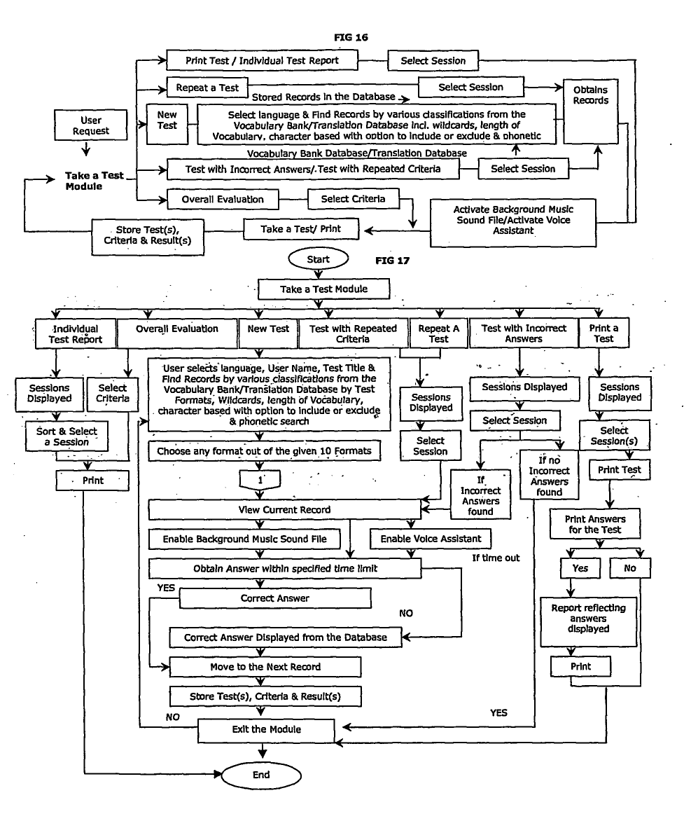

FIG. 23 describes the System Operation of Overall Evaluation Report Module explaining that the Module is based on user actions.

The user selects the criteria and then the System waits for the next user action. The user can either print the Report and/or Graph based on the selected criteria. The System then waits for the next user action.

On giving the Close command the System gets notified and the user comes out from the module.

FIG. 24 describes the System State Transition Diagram of the Overall Evaluation Report Module explaining that the Module is based on the different States. The System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

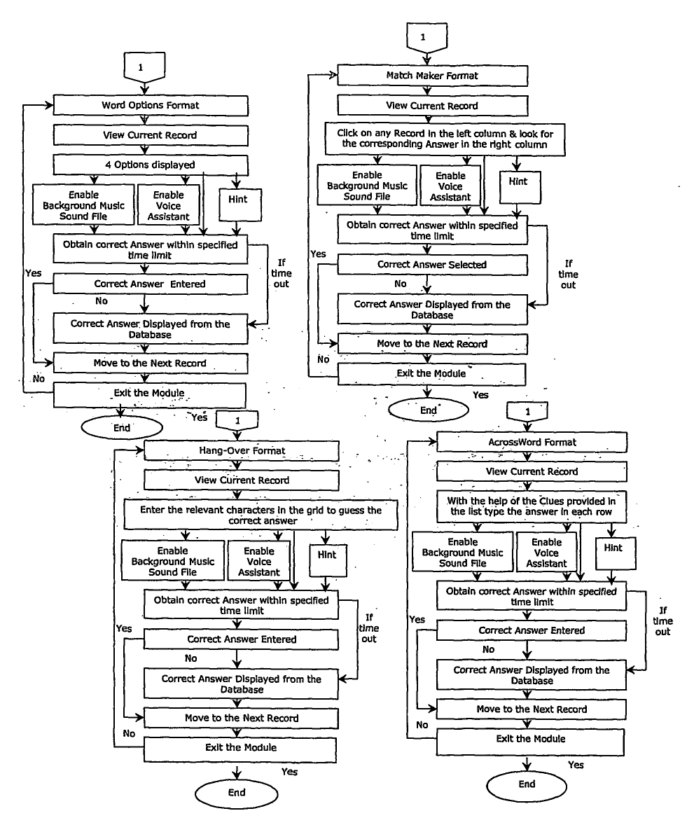

FIGS. 25 to 27 explain the System Function, System Operation and System State Transition respectively of the utility of obtaining the following Reports:
List of Vocabulary Records
List of Vocabulary Count by Category
Evaluation By Categories like Language, Source of Information, Age Group, Subjects, Difficulty Level etc.
Evaluation for Practiced Records
Evaluation for Mastered Records
Evaluation for Favourite Records
Evaluation for Bookmarked Records
User Details
Pronunciation Key(s)

FIG. 25 is the diagram of the System Function of Reports Module of the present invention. The architecture of this module comprises the following functions, which allow a user to print Reports and/or Graphs by finding the Records from the Vocabulary Bank Database/Translation Database, by none or one or more FIND conditions with the help of the User Interface.

The Reports Module, through the User Interface, causes the Control System to find and retrieve the relevant data from Vocabulary Bank Database/Translation Database. The module allows a user to:
Select a Report Type
Find existing Vocabulary item(s) from the Vocabulary Bank Database/Translation Database, by none or one or more FIND conditions to be printed
Print Report/Graph

FIG. 26 describes the System Operation of Reports Module explaining that the Module is based on user actions.

The user selects the Report to be printed and then finds & selects the Records from the Vocabulary Bank Database/Translation Database, by none or one or more FIND conditions to be included in this selected Report. The System waits for the next user action. The user can print the selected criteria, if needed. Then the System waits for the next user action. The user can mark the Records to be printed based on the selected criteria. Then the user is able to print the Records. Then the System waits for the next user action. The user can print the Report and/or Graph based on the selected criteria. The System then waits for the next user action.

On giving the Close command the System gets notified and the user comes out from the module.

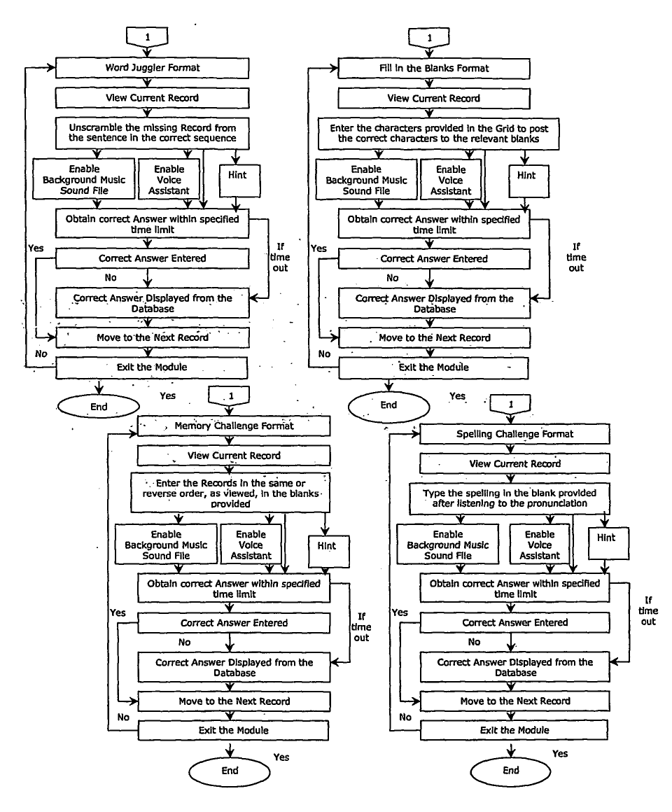

FIG. 27 describes the System State Transition Diagram of the Reports Module explaining that the Module is based on the different States. The System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 28 to 30 explain the System Function, System Operation and System State Transition respectively of the utility of creating and printing an Insta Test/Quiz using the data stored in the Vocabulary Bank Database/Translation Database, and by finding the same based on none or one or more FIND conditions, and further allowing the user to print the answers for the Insta Test/Quiz. The Results are displayed to the user in a Report format.

FIG. 28 is the diagram of the System Function of the Insta Test/Quiz Module of the present invention. The architecture of this module comprises the following functions, which allow a user to create and print an Insta Test/Quiz using the data stored in the Vocabulary Bank Database/Translation Database, and by finding the same based on none or one or more FIND conditions with the help of the User Interface.

The Insta Test/Quiz Module, through the User Interface, causes the Control System to find and retrieve the relevant data by none or one or more FIND conditions from the Vocabulary Bank Database/Translation Database. The module allows a user to:
Select a language in case of a single language Insta Test/Quiz or select 2 languages in case of an Inter-Language Insta Test/Quiz
Select Criteria and find the data from the Vocabulary Bank Database/Translation Database, to be used for the Insta Test/Quiz
Print an Insta Test/Quiz
Print Answers for the Insta Test/Quiz

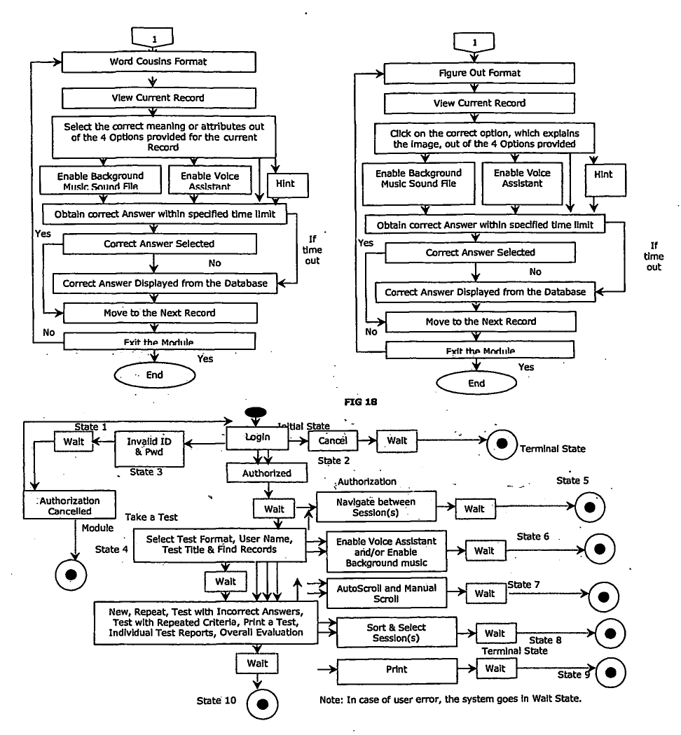

FIG. 29 describes the System Operation of the Insta Test/Quiz Module explaining that the Module is based on user actions.

The user selects the criteria and finds the data from the Vocabulary Bank Database/Translation Database. The System then waits for the next user action. The user can Print the Insta Test/Quiz with or without answers. The System then waits for the next user action.

FIG. 30 describes the System State Transition Diagram of the Insta Test/Quiz Module explaining that the Module is based on the different States. The System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

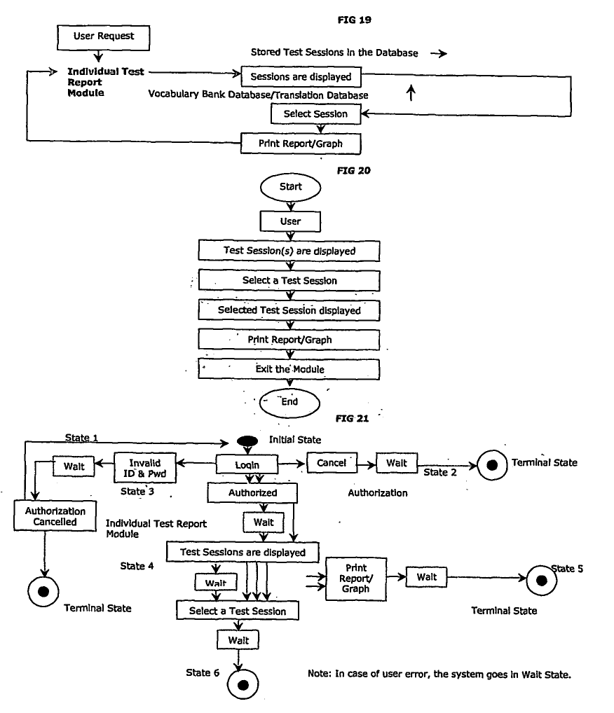

FIGS. 31 to 33 explain the System Function, System Operation and System State Transition respectively of the utility of creating Tests or Quizzes, using the data stored in the Vocabulary Bank Database/Translation Database, and by finding the same from the Vocabulary Bank Database/Translation Database, based on none or one or more FIND conditions, and further that the System being capable of verifying whether any of the Vocabulary items being selected by the user have been duplicated for the audience which will face the Test/Quiz, during any user specified earlier period, by using the backtracking utility. The Module further allows the user to export the created Test/Quiz or the Vocabulary items used in the same via the Export utility.

FIG. 31 is the diagram of the System Function of the Create a Test/Quiz Module of the present invention. The architecture of this module comprises the following functions, which allow a user to find the Records from the Vocabulary Bank Database/Translation Database, by none or one or more FIND conditions, with or without backtracking, and to Create a Test/Quiz with the help of the User Interface.

The Create a Test/Quiz Module, through the User Interface, causes the Control System to find and retrieve the relevant data from the Vocabulary Bank Database/Translation Database. The module allows a user to:
Select a language in case of a single language Test/Quiz or select 2 languages in case of an Inter-Language Test/Quiz
Assign classifications like Name of the Test/Quiz, Date of the Test/Quiz, Venue of the Test/Quiz, Category and up to 5 Sub Categories of the Test/Quiz (such Category and sub Categories are useful to, inter alia, define the details of the Test/Quiz including, but not limited to the details of the audience facing the Test/Quiz)
Find existing Vocabulary item(s) from the Vocabulary Bank Database/Translation Database, with or without backtracking by none or one or more FIND conditions
Sort & Select Vocabulary item(s)
Assign marks per Vocabulary question
Export the Vocabulary items used in the Test/Quiz as a Database file
Export the Test/Quiz itself as a Database file

FIG. 32 describes the System Operation of the Create a Test/Quiz Module explaining that the Module is based on user actions.

The user selects the Language(s), No. of Records, assigns classifications to the Test/Quiz and then finds the Records from the Vocabulary Bank Database/Translation Database, by none or one or more FIND conditions from the Database. The System then waits for the next user action. The user can also Sort & Select the Records. The System then waits for the next user action. After creating the Test/Quiz, the user can Export the Vocabulary items used in the Test/Quiz or can Export the Test/Quiz itself. The System then waits for the next user action.

On giving the Close command the System gets notified and the user comes out from the module.

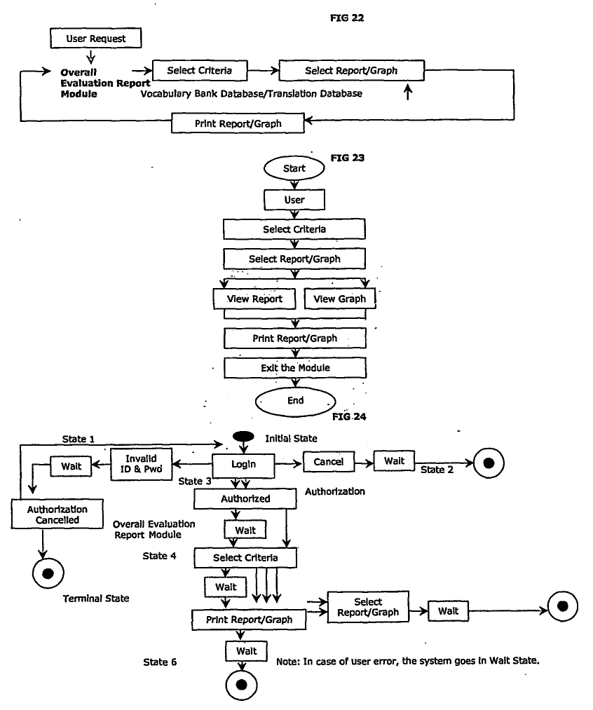

FIG. 33 describes the System State Transition Diagram of the Create a Test/Quiz Module explaining that the Module is based on the different States. The System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 34 to 36 explain the System Function, System Operation and System State Transition respectively of the utility of marking any selected Record(s) as “Set for Practice” or “Mastered”, using the data from the database, such data having been selected by the user from the Vocabulary Bank Database/Translation Database by finding the same based on none or one or more FIND conditions.

FIG. 34 is the diagram of the System Function of Set for Practice/Mastered items Module of the present invention. The architecture of this module comprises the following functions, which allow a user to Set Record(s) for Practice or as Mastered, which Record(s) are found from the Vocabulary Bank Database/Translation Database, by none or one or more FIND conditions with the help of the User Interface.

The Set for Practice/Mastered Items Module, through the User Interface, causes the Control System to find and retrieve the relevant data from Vocabulary Bank Database/Translation Database. The module allows a user to:
Find Vocabulary items from the Vocabulary Bank Database/Translation Database, by none or one or more FIND conditions
Sort & Select Vocabulary items
“Set for Practice” a Vocabulary item
Set as “Mastered” a Vocabulary item

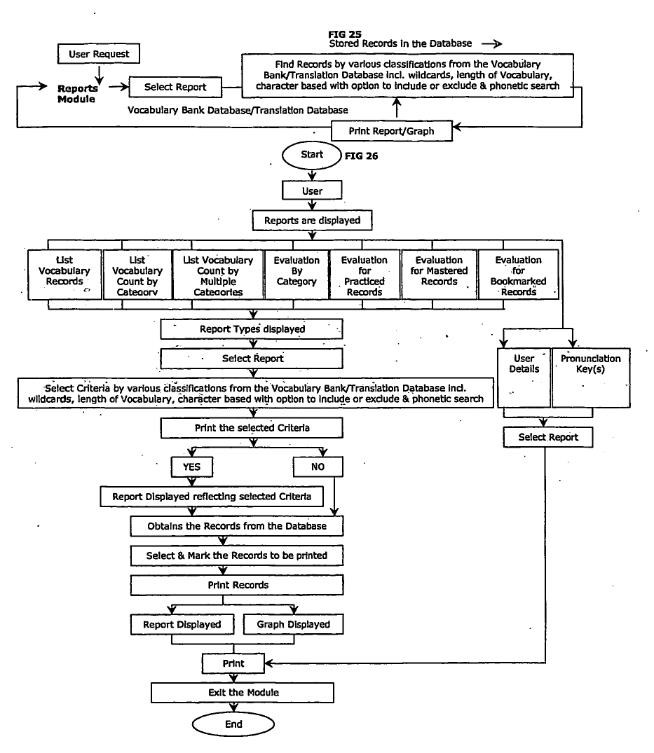

FIG. 35 describes the System Operation of Set for Practice/Mastered Items Module explaining that the Module is based on user actions.

The user finds the Records from the Vocabulary Bank Database/Translation Database, by none or one or more FIND conditions and waits for the next user action. The user can Sort & Select the desired Record(s) and then after selection can set the selected Record(s) as Set for Practice/Mastered. The System then waits for the next user action.

On giving the Close command the System gets notified and the user comes out from the module.

FIG. 36 describes the System State Transition Diagram of the Set for Practice/Mastered Module explaining that the Module is based on the different States. The System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

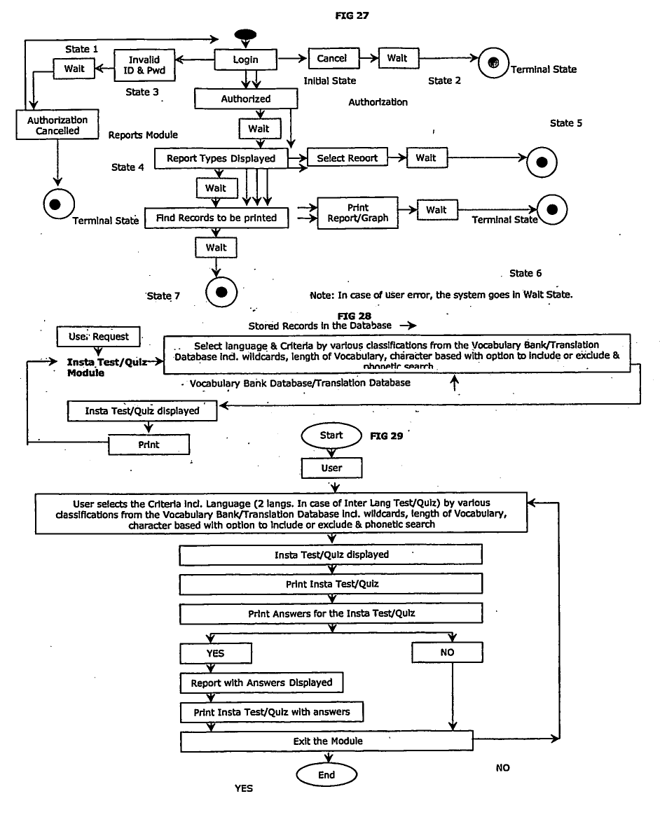

FIGS. 37 to 39 explain the System Function, System Operation and System State Transition respectively of the utility of Modifying a Record stored in the Vocabulary Bank Database/Translation Database—EXAMPLE—The System allows the user to modify any part of an existing Record by using the Edit utility. A Record entered under the subject MEDICAL PROFESSION, being decided by the user to be modified, can be instead stored under the subject NURSES. This would hold true to any part of the Record being wanted to be modified by the user, in that, any part or parts of the Record is allowed to be modified by the user. There is a further utility of “Global Modification” wherein Record(s) can be “found and replaced/modified” Globally. The Records can be replaced/modified Globally by finding them from the Vocabulary Bank Database/Translation Database based on none or one or more FIND conditions, the Results being displayed to the user in a grid format with a further utility to Sort the Results, Ascending or Descending, by the relevant classifications, and further allowing the user to select the Records to be Globally replaced/modified from the result grid.—EXAMPLE—The user may want to change the subject of some or all Vocabulary items classified under the subject MEDICAL PROFESSION to the subject NURSES. The Global utility would permit the user to make such modifications across multiple Vocabulary items instead of modifying the same one by one.

FIG. 37 is the diagram of the System Function of Global Modification Module of the present invention. The architecture of this proposed module comprises the following functions, which allow a user to Find & Modify/Replace part(s) of the Vocabulary Globally, as desired, by finding the Vocabulary item(s) from the Vocabulary Bank Database/Translation Database by none or one or more FIND conditions with the help of the User Interface.

The Global Modification Module, through the User Interface, causes the Control System to find and retrieve the relevant data from the Vocabulary Bank Database/Translation Database. The module allows a user to:
Find existing Vocabulary item(s) by none or one or more FIND conditions
Sort & Select Vocabulary item(s)
Find & Replace/Modify part(s) of Vocabulary item(s) Globally

FIG. 38 describes the System Operation of the Global Modification Module explaining that the Module is based on user actions.

Once the user finds the Vocabulary item(s) from the Vocabulary Bank Database/Translation Database, by none or one or more FIND conditions the user can Sort & Select the Vocabulary item(s) and then the System waits for the next user action. The Control System retrieves that particular Vocabulary item from the Database. Then the user modifies (Finds & Replaces) part(s) of the selected Vocabulary items Globally through the User Interface. The System then waits for the next user action.

On giving the Close command the System gets notified and the user comes out from the module.

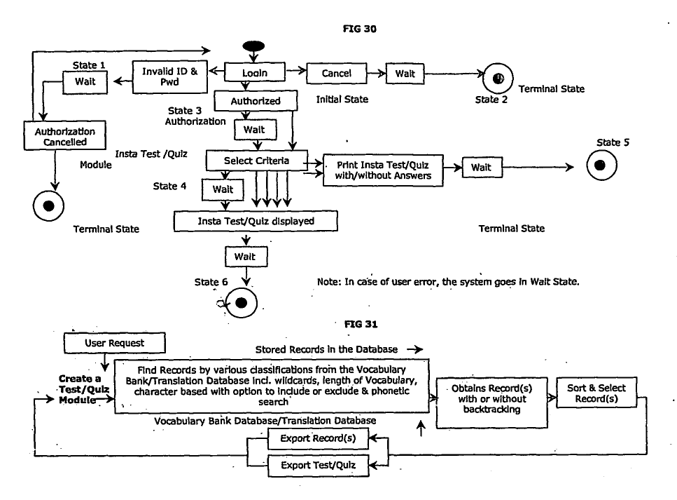

FIG. 39 describes the System State Transition Diagram of the Global Modification Module explaining that the Module is based on the different States. The System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 40 to 42 explain the System Function, System Operation and System State Transition respectively of the utility of Deleting a Record stored in the Vocabulary Bank Database/Translation Database, and having the further utility of “Global Delete” wherein the user can select the Records to be Globally Deleted. The Records can be deleted Globally by finding them from the Vocabulary Bank Database/Translation Database based on none or one or more FIND conditions, the Results being displayed to the user in a grid format with a further utility to Sort the Results, Ascending or Descending, by the relevant classifications, and further allowing the user to select the Records to be Globally Deleted from the result grid. Any Record deleted is sent to the Recycle Bin of the System.

FIG. 40 is the diagram of the System Function of Global Delete Module of the present invention. The architecture of this module comprises the following functions, which allow a user to delete Vocabulary items globally by finding the Vocabulary items from the Vocabulary Bank Database/Translation Database by none or one or more FIND conditions with the help-of the User Interface.

The Global Delete Module, through the User Interface, causes the Control System to find and retrieve relevant data from Vocabulary Bank Database/Translation Database. The module allows a user to:
Find existing Vocabulary item(s) by none or one or more FIND conditions
Sort & Select Vocabulary item(s)
Delete Vocabulary items Globally (which goes to Recycle Bin of the System)

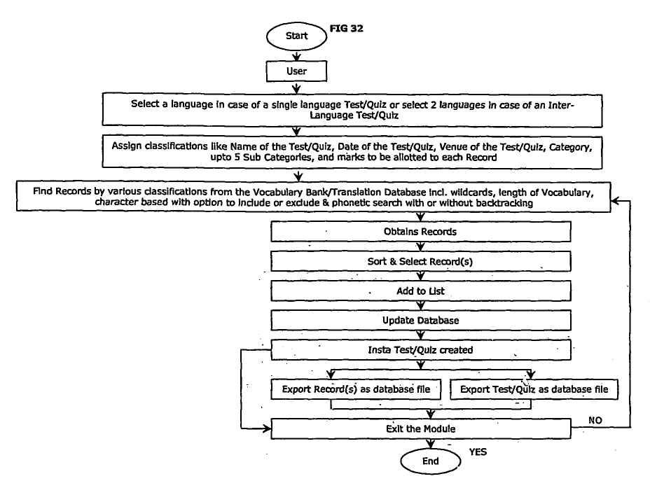

FIG. 41 describes the System Operation of the Global Delete Module explaining that the Module is based on user actions. Once the user finds the Vocabulary items from the Vocabulary Bank Database/Translation Database by none or one or more FIND conditions, the user can Sort & Select the Vocabulary items and then the System waits for the next user action. Then the user deletes those selected Vocabulary items through the User Interface. The System then waits for the next user action.

On giving the Close command the System gets notified and the user comes out from the module.

FIG. 42 describes the System State Transition Diagram of the Global Delete Module explaining that the Module is based on the different States. The System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

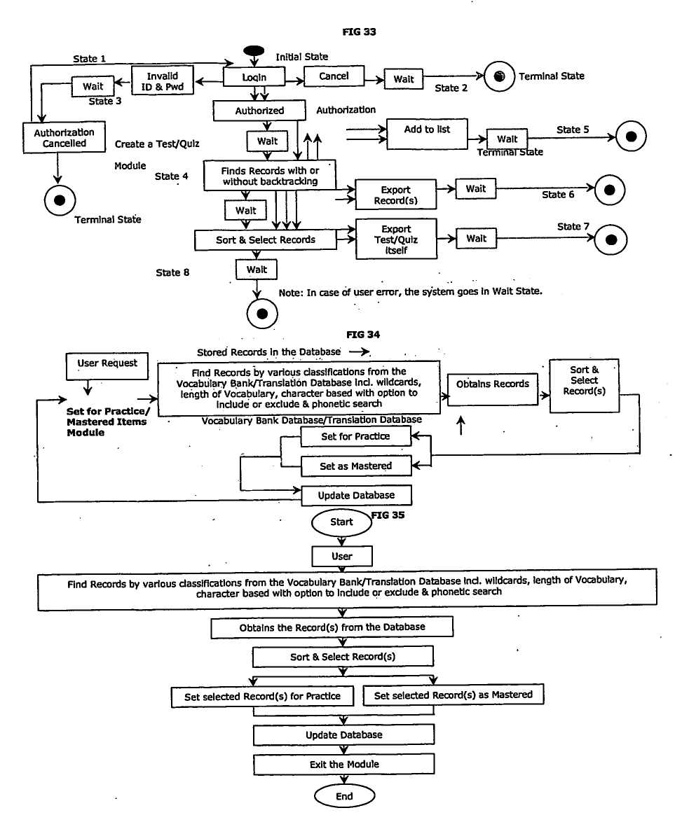

FIGS. 43 to 45 explain the System Function, System Operation and System State Transition respectively of the utility of Bookmarking or Unbookmarking one or more already Bookmarked Records in the Vocabulary Bank Database/Translation Database, and having the further utility of “Global Bookmark/Unbookmark” wherein the user can select the Records to be Globally Bookmarked/Unbookmarked, and where the user can make further selections before actually Globally Bookmarking/Unbookmarking the Records. The Records can be Bookmarked/Unbookmarked Globally, by finding the same from the Vocabulary Bank Database/Translation Database based on none or one or more FIND conditions, the Results being displayed to the user in a grid format with a further utility to Sort the Results, Ascending or Descending, by the relevant classifications, and further allowing the user to select the Records to be Globally Bookmarked/Unbookmarked, from the result grid. Bookmarking the Records with any kind of remarks, including, but not limited to bookmarking the Records with remarks like “Private” (indicating that the user has marked the Records as Private, and hence accessible only to the user with the necessary rights) or “Public” (indicating that the Records can be accessed by any user) and/or “Favourite” (indicating that the Records are the user's preferred Records) helps in finding the Records by such bookmarks.

FIG. 43 is the diagram of the System Function of Global Bookmark/Unbookmark Module of the present invention. The architecture of this module comprises the following functions, which allow a user to Bookmark/Unbookmark Vocabulary items globally by finding the Vocabulary items from the Vocabulary Bank Database/Translation Database by none or one or more FIND conditions with the help of the User Interface.

The Global Bookmark/Unbookmark Module, through the User Interface, causes the Control System to find and retrieve the relevant data from Vocabulary Bank Database/Translation Database. The module allows a user to:
Find existing Vocabulary items from the Vocabulary Bank Database/Translation Database by none or one or more FIND conditions
Sort & Select Vocabulary items
Globally Bookmark/Unbookmark Vocabulary items

FIG. 44 describes the System Operation of the Global Bookmark/Unbookmark Module explaining that the Module is based on user actions.

Once the user finds the Vocabulary items from the Vocabulary Bank Database/Translation Database by none or one or more FIND conditions the user can Sort & Select the Vocabulary items and then the System waits for the next user action. The Control System retrieves those particular Vocabulary items from the Database. Then the user can Bookmark/Unbookmark those selected Vocabulary items through the User Interface. The System then waits for the next user action. Any Bookmark Remarks added through this module would overwrite the Remarks added through the Vocabulary Bank Module.

On giving the Close command the System gets notified and the user comes out from the module.

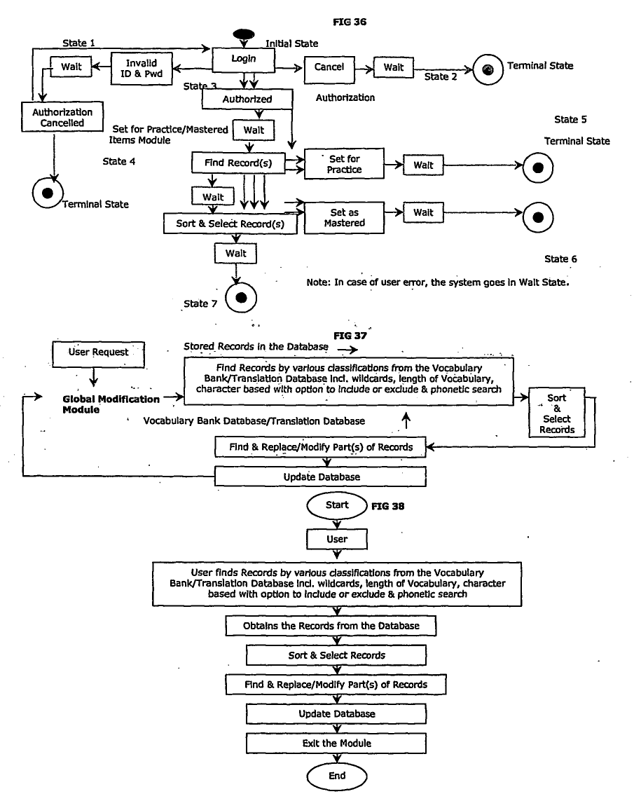

FIG. 45 describes the System State Transition Diagram of the Global Bookmark/Unbookmark Module explaining that the Module is based on the different States. The System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 46 to 48 explain the System Function, System Operation and System State Transition respectively of the utility of Exporting Records (by means of a Database file created by the System) stored in the Vocabulary Bank Database/Translation Database, by finding the same from the Vocabulary Bank Database/Translation Database based on none or one or more FIND conditions, the Results being displayed to the user in a grid format with a further utility to Sort the Results, Ascending or Descending, by the relevant classifications, and further allowing the user to select the Records to be Exported from the result grid. Records can also be Exported to various destinations by using the Print utility. A further utility allows the user to Export the Record(s) as SMS/MMS and/or Email and/or Network Messaging.

FIG. 46 is the diagram of the System Function of Export Module of the present invention. The architecture of this module comprises the following functions, which allow a user to Export Vocabulary item(s) by creating a Database file and/or as SMS/MMS and/or via Email and/or Network Messaging, with the help of the User Interface.

The Export Module, through the User Interface, causes the Control System to find and retrieve the relevant data from the Vocabulary Bank Database/Translation Database by none or one or more FIND conditions. The module allows a user to:
Find existing Vocabulary item(s) from the Vocabulary Bank Database/Translation Database by none or one or more FIND conditions
Sort & Select Vocabulary item(s)
Validate Data
Export Vocabulary item(s) as Database File and/or as SMS/MMS and/or via Email and/or Network Messaging.

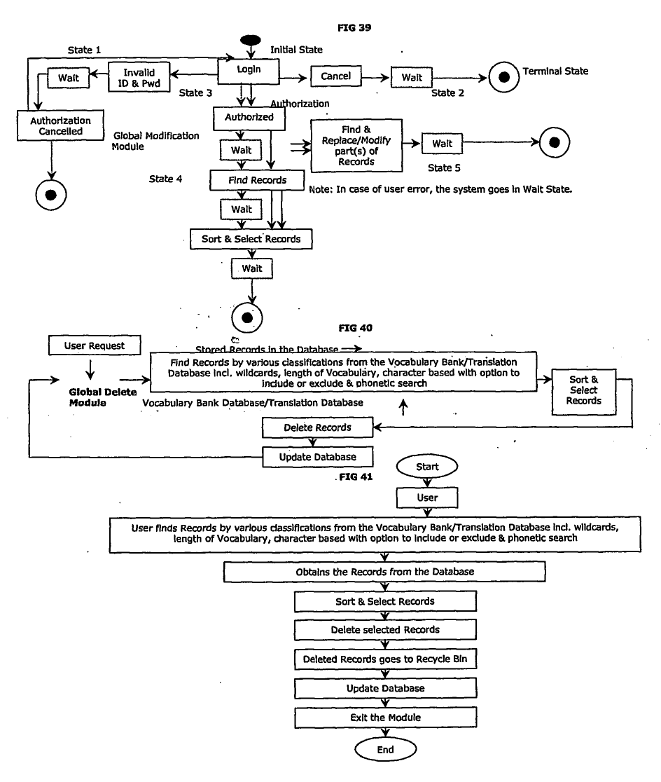

FIG. 47 describes the System Operation of Export Module explaining that the Module is based on user actions, which are performed by loops.

Once the user finds the Vocabulary item(s) from the Vocabulary Bank Database/Translation Database by none or one or more FIND conditions the System returns to the top-level loop, and waits for the next user action. The user can Sort & Select the desired Vocabulary item(s) and then after data validation can Export Vocabulary item(s) as Database File and/or as SMS/MMS and/or via Email and/or Network Messaging. The System then waits for the next user action.

On giving the Close command the System gets notified and the user comes out from the module.

FIG. 48 describes the System State Transition Diagram of the Export Module explaining that the Module is based on the different States. The System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

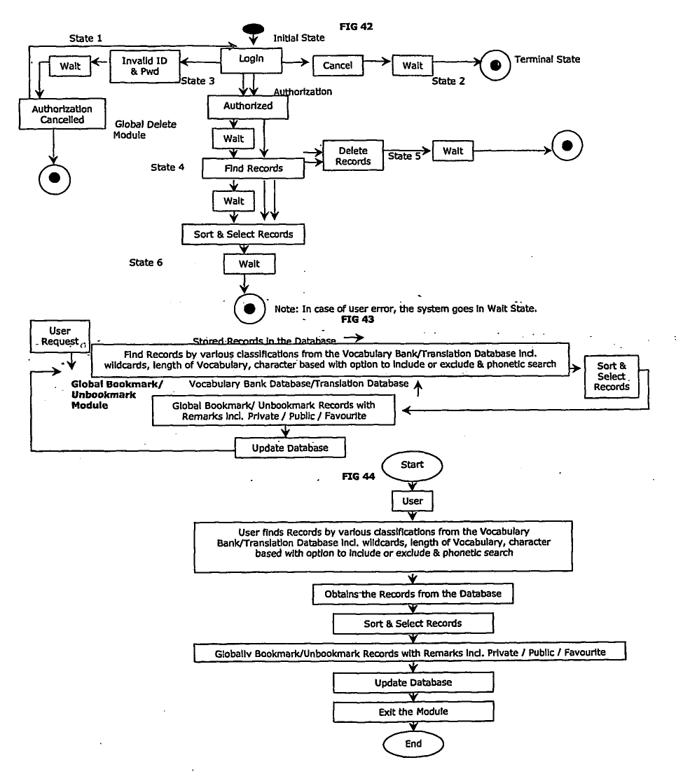

FIGS. 49 to 51 explain the System Function, System Operation and System State Transition, respectively, of the utility of Importing Records from a Database file that may have been built by other user(s) of this System, with the utility of appending the data already stored by the user in the Vocabulary Bank Database/Translation Database. The utility further comprises of displaying the Importable Records to the user in a grid format with a further utility to Sort the data, Ascending or Descending, by the relevant classifications. The utility further allows the user to make a selection of the data to be imported; thereby allowing the user to import only such data as may be required.

FIG. 49 is the diagram of the System Function of Import Module of the present invention. The architecture of this module comprises the following functions, which allow a user to Import Vocabulary item(s) with the help of the User Interface from a Database file that may have been built by other user(s) of this System.

The Import Module, through the User Interface, causes the Control System to retrieve the relevant data from a valid Database file. The module allows a user to:
Select a File
Validate the File
Get Vocabulary item(s)
Sort & Select Vocabulary item(s)
Import Vocabulary item(s)

FIG. 50 describes the System Operation of Import Module explaining that the Module is based on user actions, which are performed by loops.

Once the user retrieves the Vocabulary item(s) after File Validation the System returns to the top level loop, and waits for the next user action. The user can then Sort & Select the desired Vocabulary item(s) and can then Import the Vocabulary item(s), selectively if needed. The database gets updated and the System then waits for the next user action.

On giving the Close command the System gets notified and the user comes out from the module.

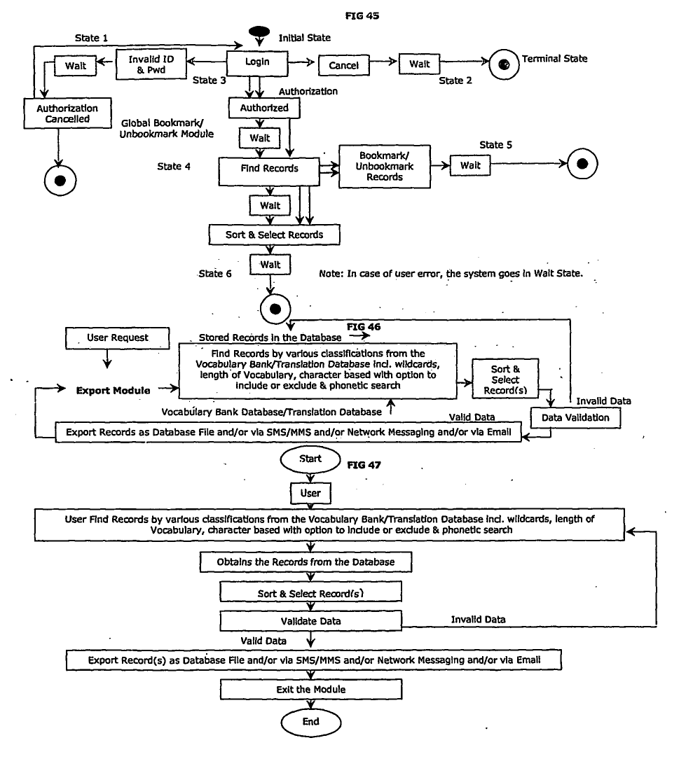

FIG. 51 describes the System State Transition Diagram of the Import Module explaining that the Module is based on the different States. The System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 52 to 54 explain the System Function, System Operation and System State Transition respectively, of the utility of Scheduling Vocabulary by finding the same from the Vocabulary Bank Database/Translation Database based on none or one or more FIND conditions, to be displayed on the user's computer, including hand held devices, at preset time intervals, with or without Voice; in the case of with Voice, the text of such Vocabulary items being additionally displayed on the user's computer, including hand held devices, and simultaneously being spoken by a character, through an embedded text to speech engine and further that the user has the ability to select and Schedule the Vocabulary item(s). A further utility allows the user to send the Record as SMS/MMS and/or via Email and/or Network Messaging at any time before the Scheduling Session is over.

FIG. 52 is the diagram of the System Function of Vocabulary Scheduler Module of the present invention. The architecture of this module comprises the following functions, which allow a user to find the Vocabulary items from the Vocabulary Bank Database/Translation Database by none or one or more FIND conditions and schedule them as desired with the help of the User Interface.

The Vocabulary Scheduler, through the User Interface, causes the Control System to find and retrieve the relevant data from the Vocabulary Bank Database/Translation Database. The module allows a user to:
Select a language
Find existing Vocabulary items from the Vocabulary Bank Database/Translation Database by none or one or more FIND conditions
Sort & Select Vocabulary items
Schedule time interval between the selected Vocabulary items
Activate Background Music Sound File
Activate Voice Assistant
Send Vocabulary item(s) as SMS/MMS and/or via Email and/or Network Messaging when the Vocabulary item is displayed

NOTE: The user can decide whether the Scheduler should remain active in the System tray of the user's computer irrespective of whether the System is running or not.

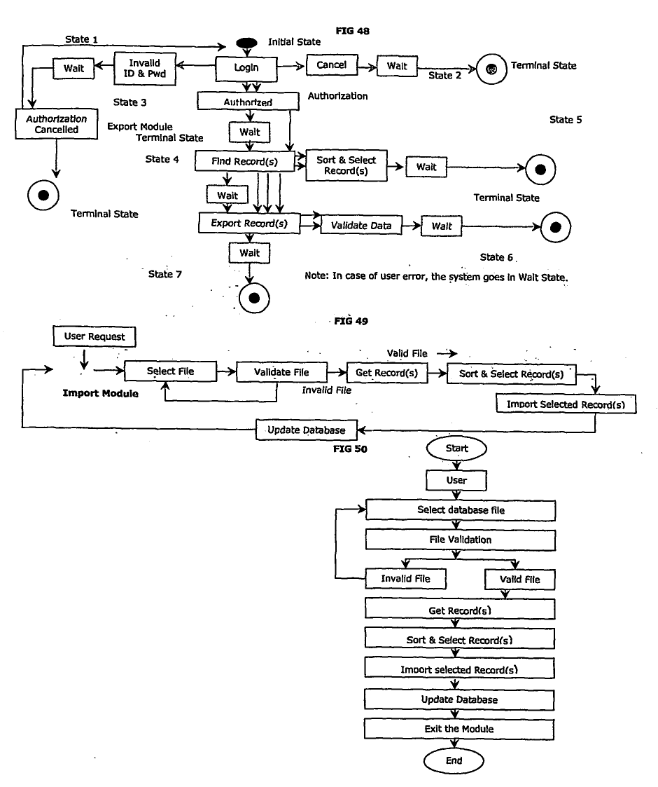

FIG. 53 describes the System Operation of the Vocabulary Scheduler Module explaining that the Module is based on user actions, which are performed by loops.

The user selects the Language, No. of Vocabulary item(s) and then finds the Vocabulary item(s) from the Vocabulary Bank Database/Translation Database by none or one or more FIND conditions from the Database. The System then waits for the next user action. The user can also select to listen to a Background Music Sound File or can select to activate the Voice Assistant during the scheduling activity and after this the user can notify the System that the session is finished. The System then waits for the next user action. The scheduled Vocabulary item(s) gets displayed according to the specified time. The user can also send the Vocabulary item(s) as SMS/MMS and/or via Email and/or Network Messaging. The System then waits for the next user action.

On giving The Close command the System gets notified and the user comes out from the module.

FIG. 54 describes the System State Transition Diagram of the Vocabulary Scheduler Module explaining that the Module is based on different States. The System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

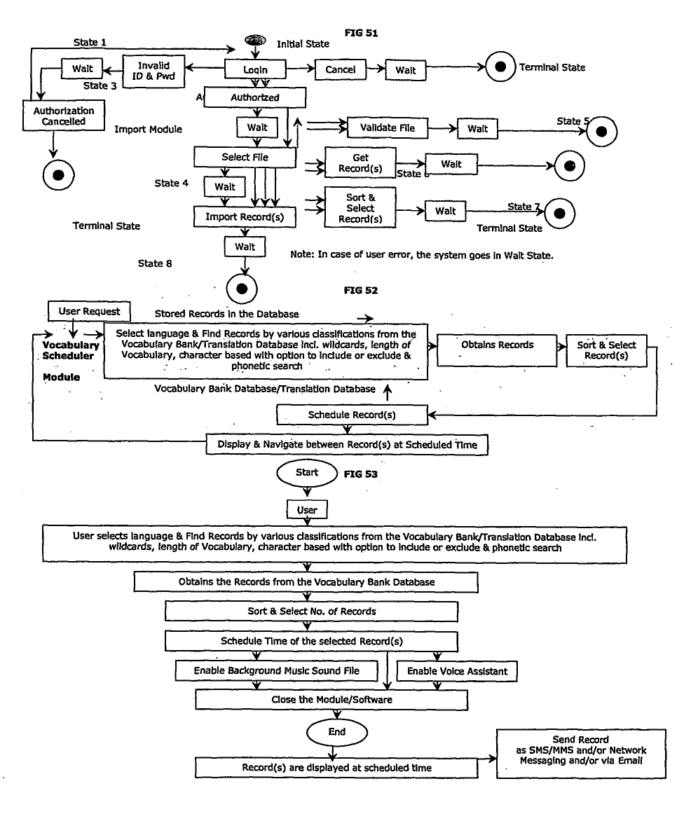

FIGS. 55 to 57 explain the System Function, System Operation and System State Transition respectively, of the utility of Restoring or Permanently Deleting a Record, which may have been deleted by the user from the Vocabulary Bank Database/Translation Database, and having the further utility of selectively Restoring or Permanently Deleting a Record or a group of Records, the Records being displayed to the user in the Recycle Bin of the System in a grid format with a further utility to Sort the Results, Ascending or Descending, by the relevant classifications, and further allowing the user to select the Records to be Deleted or Restored from the result grid. Any Record that is Restored is sent back to the Vocabulary Bank Database/Translation Database, with its original ID Number. Any Record that is Permanently Deleted is permanently removed from the System.

FIG. 55 is the diagram of the System Function of Recycle Bin Module of the present invention. The architecture of this module comprises the following functions, which allow a user to Restore/Permanently Delete Vocabulary item(s) with the help of the User Interface.

The Recycle Bin Module of the System, through the User Interface, causes the Control System to display the deleted data of Vocabulary Bank Database/Translation Database. The module allows a user to:
Sort & Select Vocabulary item(s)
Restore/Permanently Delete Vocabulary item(s)

FIG. 56 describes the System Operation of the Recycle Bin Module of the System explaining that the Module is based on user actions. The selection of Recycle Bin Module of the System displays all the Vocabulary item(s), that may have been deleted earlier, and are still lying in the Recycle Bin of the System. The user can Sort & Select the displayed Vocabulary item(s). The System then waits for the next user action. The user is allowed to either Permanently Delete or Restore the selected Vocabulary item(s) through the User Interface. The System then waits for the next user action. The System exercises sufficient caution to ensure that any Records that are in use in either a Test/Quiz or a Practice Session or a Scheduled Session are not Permanently Deleted.

On giving the Close command the System gets notified and the user comes out from the module.

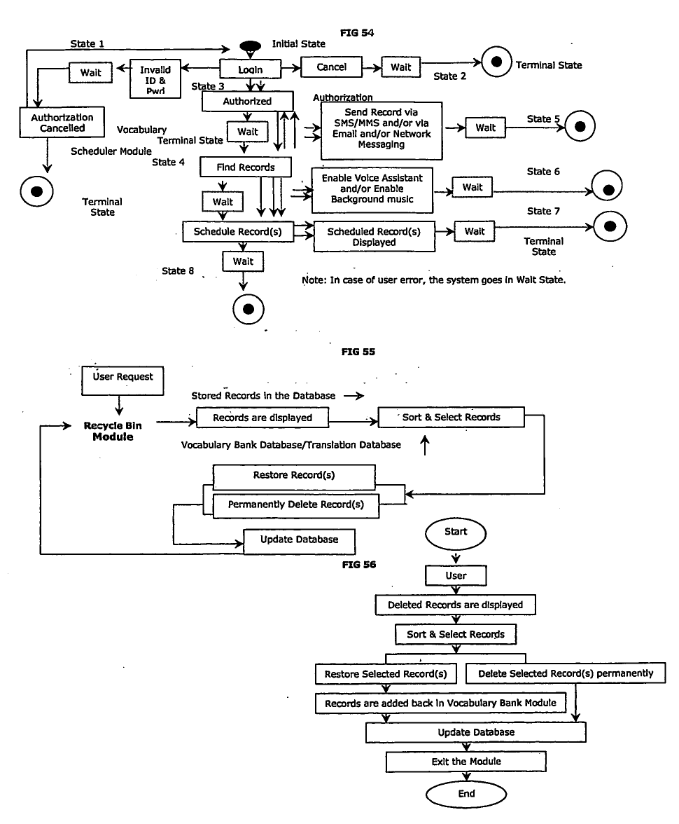

FIG. 57 describes the System State Transition Diagram of the Recycle Bin Module of the System explaining that the Module is based on different States. The System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 58 to 60 explain the System Function, System Operation and System State Transition respectively, of software maintenance Tools such as Back Up, Repair, Restore, Compression of the entire Database and System Check. There are other tools such as Start Up Options, Data Entry Options, Change Sound, Test Repeat Options, Customize Header and Footer, Graphical User Interface Manager, Labels, Select Skin, Remove Practice Session(s) and Help. The System allows the creation of Sub Users who are able to set their own preferences with respect to the relevant tools.

The System wherein one or more module(s)/utility(s) or program(s) of the same can Operate within a browser and/or other viewing and/or processing program's, and can operate on one or more computers, including hand held devices.

FIG. 58 is the diagram of the System Function of Tools/Help Menu Options Module of the present invention. The architecture of these options comprises the following functions, which allow a user to select any option for Customization including software maintenance and updating of Database.

The Tools/Help Menu Options Module, through the User Interface, retrieves and brings forth the following options:
Back Up—This utility allows the user to back up the Database(s)
Repair/Restore/Compress—This utility allows the user to repair/restore/compress the Database(s)
Change Sound—This utility allows the user to change the background, applause and regret sounds
System Check—This utility allows the user to initiate a System Check
Start Up Options—This utility allows the user to set conditions like Login Screen and Quick Start Screen to appear each time the System is initiated
Data Entry Options—This utility allows the user to copy an existing classification and previously entered data for new data input.
Test Repeat Options—This utility allows the user to copy an existing classification and previously entered data for new data input.
Label Printing—This utility allows the user to print user information labels.
Customize Header and Footer—This utility allows the user to customize the Header and Footer for the Printed outputs.
Customize Graphical User Interface—This utility allows the user to change the Labels that appear on the User Interface.
Select Skin—This utility allows the user to select the “skins” for the User Interface.
Remove Practice Session(s)—This utility allows the user to delete earlier Practice Sessions, such deletions being capable of being made selectively.
Help—This utility allows the user to invoke the Help files, which provide Help on how best to use the System.

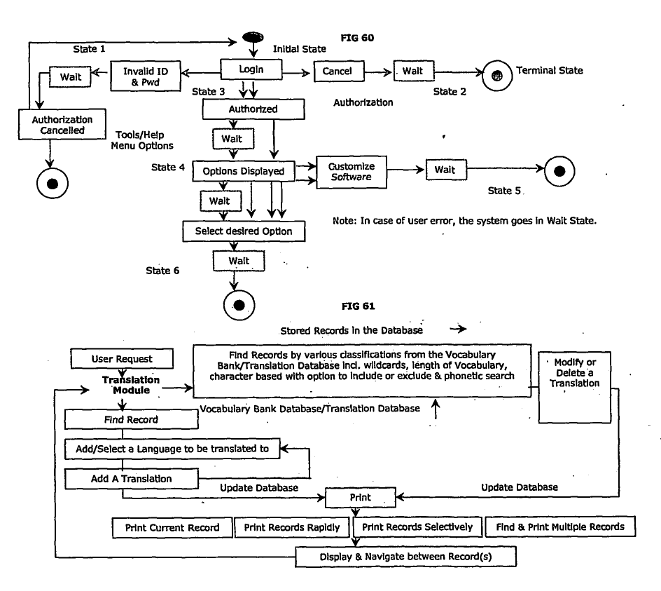

FIG. 59 describes the System Operation of the Tools/Help Menu Options Module explaining that the Module is based on user actions. Through these options, the user can select any option for customization, including software maintenance and updating of Database.

FIG. 60 describes the System State Transition Diagram of the Tools/Help Menu Options Module explaining that the Module is based on different States. The System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

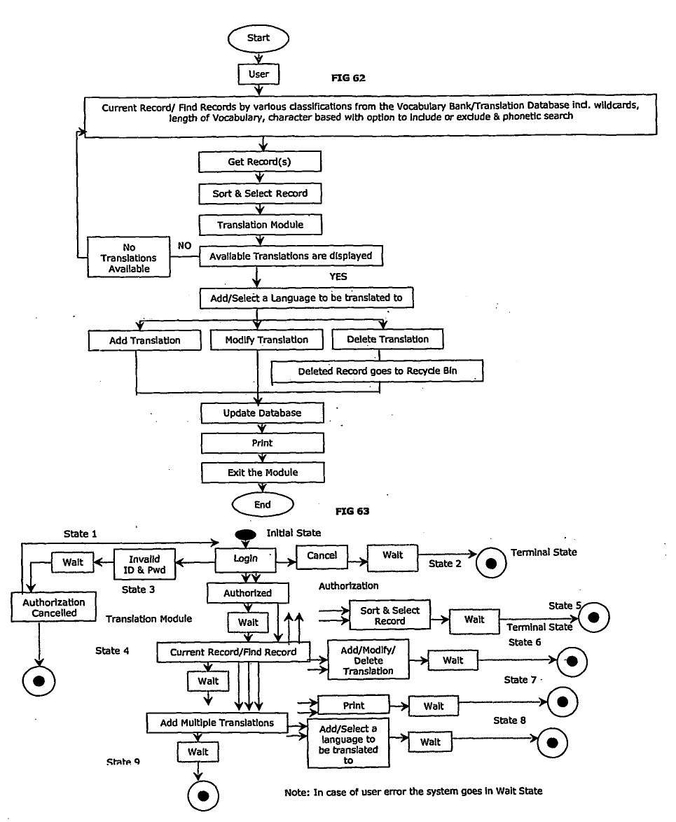

FIGS. 61 to 66 explain the System Function, System Operation and System State Transition respectively, of a Translation utility, allowing the user to consider any Record as a parent language Record and Translate the same into one or more languages of the user's choice, the translation activity happening from a Translation Module which is invoked in the Vocabulary Bank Module, and further that all of the features and/or utility(s)/functionality(s) of the System remain common to the translated Record as would be applicable to the parent language Record. There is a further utility of “Global Translation” where Record(s) can be found and part(s) of the Record(s) can be translated Globally. The Records can be translated Globally by finding them from the Vocabulary Bank Database/Translation Database based on none or one or more FIND conditions, the Results being displayed to the user in a grid format with a further utility to Sort the Results, Ascending or Descending, by the relevant classifications, and further allowing the user to select the Records to be Globally translated from the result grid.—EXAMPLE—The user may want to Translate the Subject of some or all Vocabulary items having been classified under the Subject MEDICAL PROFESSION from English to Spanish. The Global utility would permit the user to Translate this across multiple Records instead of translating the same one by one.

FIG. 61 is the diagram of the System Function of Translation Module of the present invention. The architecture of this module comprises the following functions, which allow a user to consider any Vocabulary item as a parent language Vocabulary and Translate the same into one or more languages of the user's choice.

The Translation Module, through the User Interface, causes the Control System to find and retrieve the relevant data from the Vocabulary Bank Database/Translation Database. The module allows a user to:
Find existing Vocabulary item(s) from the Vocabulary Bank Database/Translation Database by none or one or more FIND conditions
Sort & Select Vocabulary item(s)
Select/Add a language
Add Translations
Modify Translations
Delete Translations
Print

FIG. 62 describes the System Operation of Translation Module explaining that the Module is based on user actions, which are performed by loops.

The user finds the Vocabulary items from the Vocabulary Bank Database/Translation Database by none or one or more FIND conditions. The user then sorts & selects the Vocabulary items and then the System waits for the next user action. Then the user selects a Vocabulary item to be translated and translates the same, field by field, through the User Interface. The user can also modify an earlier translation or delete the same. The System then waits for the next user action. The user is able to Print the Record from this module after selecting the appropriate print criterion. The System then waits for the next user action.

On giving the Close command the System gets notified and the user comes out from the module.

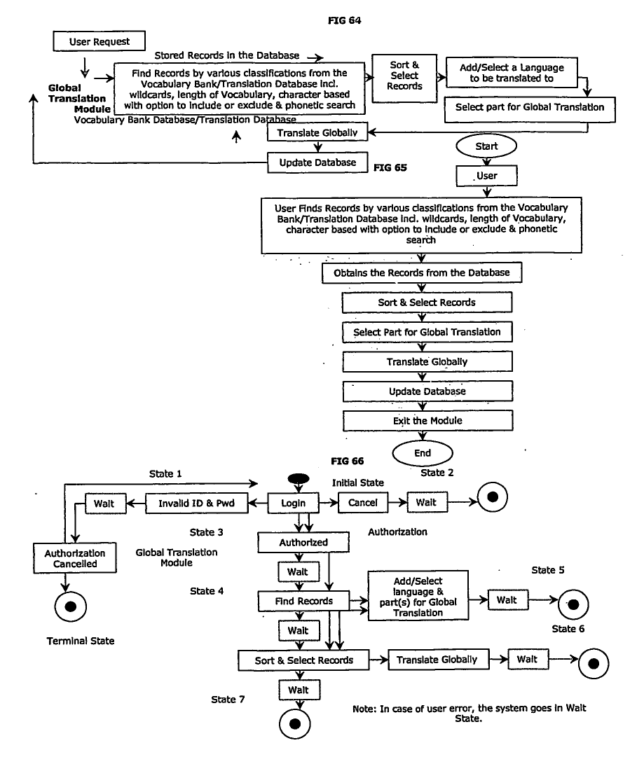

FIG. 63 describes the System State Transition Diagram of the Translation Module explaining that the Module is based on different States. The System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State-and entering another State.

FIG. 64 is the diagram of the System Function of Global Translation Module of the present invention. The architecture of this module comprises the following functions, which allow a user to Translate a selected part of the parent language Vocabulary across several Vocabulary items Globally in one or more languages of the user's choice.

The Global Translation Module, through the User Interface, causes the Control System to find Vocabulary Items by none or one or more FIND conditions and retrieve the relevant data from the Vocabulary Bank Database/Translation Database. The module allows a user to:
Find existing Vocabulary items from the Vocabulary Bank Database/Translation Database by none or one or more FIND conditions
Sort & Select Vocabulary items
Select/Add a language
Select part for Global Translation
Translate Globally

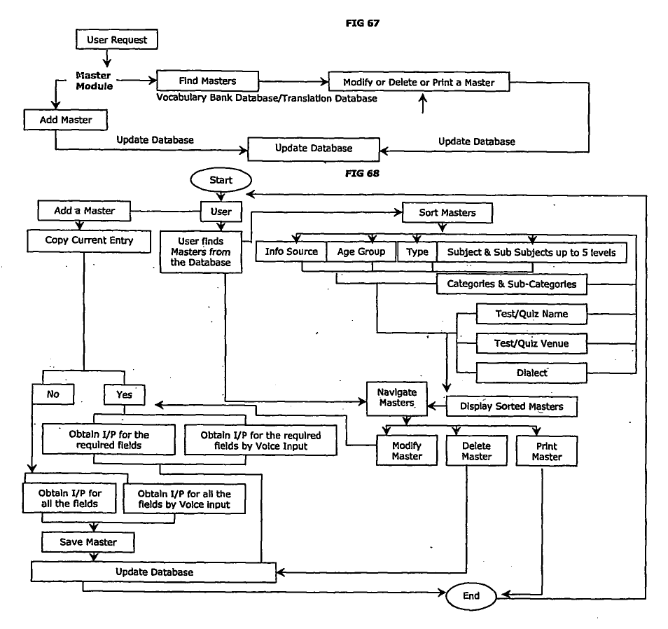

FIG. 65 describes the System Operation of Global Translation Module explaining that the Module is based on user actions. Through this Translation Module, the user can Translate a part of a Vocabulary across multiple Vocabulary items Globally.

Once the user finds the Vocabulary items from the Vocabulary Bank Database/Translation Database by none or one or more FIND conditions the user can Sort & Select the Vocabulary items and then the System waits for the next user action. Then the user can select part of the Vocabulary items and Translate the same across the Vocabulary items through the User Interface. The System then waits for the next user action.

On giving the Close command the System gets notified and the user comes out from the module.

FIG. 66 describes the System State Transition Diagram of the Global Translation Module explaining that the Module is based on different States. The System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

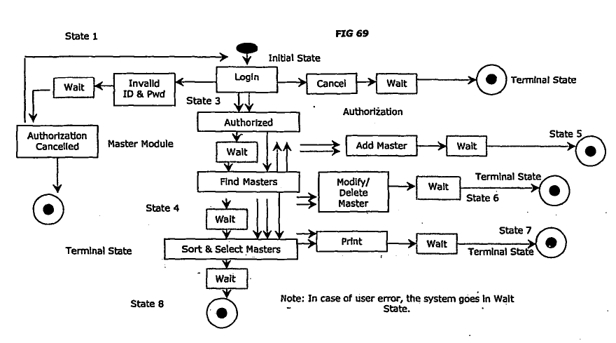

FIGS. 67 to 69 explain the System Function, System Operation and System State Transition respectively, of at least 1 well classified Master module which accepts data (such data capable of being accepted from more than one user at the same time), with or without Voice. The System provides the utility of creating, editing, deleting, printing, navigating, finding Masters like; User, Info Source, Type of Vocabulary, Dialect, Age Group, Difficulty Level, Subjects, Sub subjects, Part of Speech, Language, Test/Quiz Name, Test/Quiz Venue, Category, Sub-Categories, etc. with sufficient security so as not to allow the deletion of any Master of a Record that may be in use.

FIG. 67 is the diagram of the System Function of Master Module of the present invention. The architecture of this module comprises the following functions, which allow a user to create and store Masters by none or one or more FIND conditions with the help of the User Interface.

The Master Module through the User Interface, causes the Control System to retrieve the relevant data from the Vocabulary Bank Database/Translation Database. The module allows a user to:
Find existing Master(s) by none or one or more FIND conditions
Sort & Select Master(s)
Add & Save Master(s)
Modify & Save Master(s)
Delete Master(s)
Copy Current Entry
Print Master(s)
Go To a Master

FIG. 68 describes the System Operation of the Master Module explaining that the Module is based on user actions, which are performed by loops.

The Add functionality allows the user to Input data in all the fields. The functionality is controlled through a top-level loop. The Control System updates the Database and then the System waits for the next user action.

The FIND functionality is controlled through a top-level loop wherein the user is, asked to enter/select the FIND criteria, to bring forth Masters based on the FIND criteria. After finding the Masters, the user can sort the Masters by different classifications and can then modify, delete or print the Masters. After modification, if the user saves the Master, the Database gets updated and then the System waits for the next user action. Similarly, after deleting a Master, the Database gets updated and then the System waits for the next user action.

The Copy Current Entry functionality is controlled through a top-level loop. This functionality allows the user to copy the data existing in one or more of the fields of the current Master and make the necessary additions/modifications in the other fields. The Control System updates the new Master in the Database and then the System waits for the next user action.

The Printing functionality is controlled through a top-level loop. The user can print the Masters. The Control System retrieves the Master(s) from the Database and then the System waits for the next user action.

The Navigation functionality allows the user to navigate between the Masters.

On giving the Close command the System gets notified and the user comes out from the module.

FIG. 69 describes the System State Transition Diagram of the Master Module explaining that the Module is based on different States. The System receives events from the user(s), and each event causes the transition from one State to another within the module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

Thus, while there have been shown and described and pointed out fundamental novel features of the present invention as applied to preferred embodiments thereof, it will be understood that the described embodiments are to be considered in all respects only as illustrative and not restrictive and various omissions, substitutions and changes in the form and details of the methods described may be made by those skilled in the art without departing from the spirit of the present invention. For example, it is expressly intended that all combinations of those elements and/or method steps which perform substantially the same functions in substantially the same way to achieve the same results are within the scope of this invention. Substitutions of elements from one described embodiment to another are also fully intended and contemplated. It is the intention, therefore, to be limited only as indicated by the scope of the claims appended hereto. All changes which come within the meaning and range of equivalency of the claims are to be embraced within their scope.

1-19. (canceled)

20. A system for building and sharing one's own interactive dictionary and/or thesaurus of vocabulary, in one or more languages, using a computer system comprising:
(a) a User Interface;
(b) one or more well-classified databases to store data user wise including a User Database;
(c) at least one well-classified data input organizing and management module;
(d) modules for sharing, invoking, storing, evaluating, and improving one's vocabulary including words, terms, and phrases, using the data from the databank, said data having been selected by a user by finding the same by none or one or more “FIND” conditions; and
(e) a control system acting as a bridge between the User Interface and the databases.

21. The system according to claim 20 wherein the modules include a Practice Session Module for allowing the user to invoke and store a practice session for continuous improvement of one's vocabulary including words, terms, phrases, using the data from the databank, such data having been selected by the user by finding the same, from the databank, by none or one or more “FIND” conditions.

22. The system according to claim 20 wherein the modules include a Take a Test Module, Individual Test Report Module, and Overall Evaluation Report Module, for allowing the user to invoke and store self evaluation tests in one language or between any two languages, being taken in a variety of test formats, and to obtain evaluation reports of said tests, using the data from the databank, said data being selected by the user by finding the same from the databank by none or one or more “FIND” conditions.

23. The system according to claim 20 wherein the modules include a Create a Test/Quiz Module and an Insta Test/Quiz Module for allowing the user to create tests and/or quizzes in one language or between any two languages, by various classifications, using the data from the databank, said data being selected by the user by finding the same from the databank by none or one or more “FIND” conditions.

24. The system according to claim 23 wherein the Create a Test/Quiz Module enables verifying whether any of the words, terms, and phrases, vocabulary being selected by the user for the test/quiz have been used during any user specified earlier period for the persons who will face the test/quiz, thus avoiding duplication of questions.

25. The system according to claim 20 wherein the modules include a Vocabulary Scheduler Module for allowing the user to schedule vocabulary including words, terms, phrases, by finding the same from the databank by none or one or more “FIND” conditions, and said words, terms, phrases are brought up on the user's computer system, at preset time intervals.

26. The system according to claim 20 wherein the modules include an Export Module for allowing the user to export data from the databank, said data being selected by the user by finding the same by none or one or more “FIND” conditions.

27. The system according to claim 20 wherein the modules include an Import Module for allowing the user to import data built by one or more other users.

28. The system according to claim 27 wherein the Import Module further includes a utility for selectively importing the data.

29. The system according to claim 20 wherein said data input organizing and management module allows the user to classify the data by well-defined classifications like Date, Language, Source of Information, Type of Vocabulary, Dialect, Age Group, Difficulty Level, Subject and Sub subjects bearing a parent-child relationship and Part of Speech.

30. The system according to claim 20 wherein said data input organizing and management module allows the user to add a short and long meaning, or brief and detailed meaning, to the vocabulary, add details of an origin of the vocabulary, add multiple usage examples to the vocabulary, assign quiz options to the vocabulary for the purpose of evaluations, assign attributes like synonyms, antonyms, homonyms, homophones, homographs, related vocabulary, glossary, attach image, animation and/or sound files and/or associate more Information to a record in the form of URLs, files, remarks.

31. The system according to claim 20 wherein the modules include a Global Attachment Module for allowing the user to attach image, animation, or sound files to a record.

32. The system according to claim 20 wherein the modules include a Global Association Module for allowing the user to associate files, URLs, or remarks to a record.

33. The system according to claim 20 wherein said data input organizing and management module further includes a utility for copying of existing classification and previously entered data for new data input by the user for ease of data entry.

34. The system according to claim 20 wherein the modules include a Global Modification Module for allowing the user to modify a record individually and globally.

35. The system according to claim 20 wherein the modules include a Global Delete Module for allowing the user to delete a record individually and globally.

36. The system according to claim 20 wherein the modules include a Recycle Bin Module for allowing the user to restore or permanently remove a record individually or plurally from the system.

37. The system according to claim 20 wherein the modules include a Reports Module for allowing the user to print reports and/or graphs about the data in the databank, by finding the same by none or one or more FEND conditions.

38. The system according to claim 20 wherein the FIND conditions are defined by classifications like Date, Record ID, Language, Source of Information, Type of Vocabulary, Dialect, Age Group, Difficulty Level, Subjects, Sub subjects, Part of Speech as well as by keywords, wildcards, length of vocabulary, plurality of characters with a choice to include or exclude such characters used in the vocabulary, file attachments/associations or bookmark remarks including “Private” or “Public” as well as “Favorite”, whether the vocabulary is marked as “Set for Practice” or “Mastered”, phonetic search, attributes like synonyms, antonyms, homonyms, homophones, homographs, and related vocabulary.

39. The system according to claim 20 wherein the modules include a Global Bookmark/Unbookmark Module for allowing the user to bookmark or unbookmark one or more records individually or globally with bookmark remarks including “Public” or “Private”, as well as “Favourite”.

40. The system according to claim 20 wherein the modules include a Set for Practice/Mastered Items Module for allowing the user to mark one or more records individually or globally as “Set for Practice” or “Mastered”.

41. The system according to claim 20 wherein the modules include a Translation Module as well as a Global Translation Module for allowing translation of a record from one language into another of the user's choice, individually or globally.

42. The system according to claim 20 wherein the modules include a Tools/Help Menu Options Module for allowing the user to select an option for customization including system maintenance and updating of a database.

43. The system according to claim 20 wherein the modules include a Master Module for allowing the user to create and store masters for well-defined classifications.

44. The system according to according to claim 20 wherein the modules and utilities are adapted to be operated within a browser and/or other viewing and/or processing programs and to operate on one or more computer systems including hand held devices.
